(19) United States
(12) Patent Application Publication
(10) Pub. No.: US 2012/0001900 A1
(43) Pub. Date: Jan. 5, 2012

(54) GAME MACHINE, DISPLAY CONTROL METHOD, AND DISPLAY CONTROL PROGRAM

(75) Inventor: Takuro MICHIGUCHI, Aichi (JP)

(73) Assignee: KYORAKU INDUSTRIAL CO., LTD., Nagoya-Shi (JP)

(21) Appl. No.: 12/986,369

(22) Filed: Jan. 7, 2011

(30) Foreign Application Priority Data
Jun. 30, 2010 (JP) 2010-149514
Jun. 30, 2010 (JP) 2010-149515

(51) Int. Cl. G06T 15/00

(52) U.S. Cl. 345/419

(57) ABSTRACT

A game machine, a display control method, and a display control program that can express a polygonal data object created from polygonal data in a three-dimensional virtual space by line drawing according to a performance state. A three-dimensional object is generated from polygon data which connects vertex coordinates in the three-dimensional virtual space. The vertex coordinates of the polygon data on the three-dimensional object are extracted. Lines are drawn between adjoining vertex coordinates among such vertex coordinates extracted. Part of the lines are deleted based on a performance condition corresponding to a performance state provided by a game using a game medium. A three-dimensional performance image based on the three-dimensional object of which part of the lines are deleted is drawn, and displayed and controlled on a display device.

### BACKGROUND OF THE INVENTION

1. Field of the Invention

The present invention relates to a game machine, a display control method, and a display control program.

2. Description of the Prior Art

With the recent improvement of computer performance, there have been disclosed a lot of technologies for creating a three-dimensional virtual space just like a real space by using computer graphics.

Of these, a method of expressing an object in a three-dimensional space by means of a wire frame, which shows the shape of the object by lines, has been used to give a strong impression in a game that is provided by a game machine such as a pachinco machine.

A conventional technology disclosed in Japanese Patent Application Laid-Open No. 2001-231967 describes that there are stored shape data (referred to as a wire frame or object) for describing the shape of a three-dimensional body, an image (referred to as a texture) to be mapped onto the surface of the three-dimensional body, the position of the image on the three-dimensional body, and identification code corresponding to the image.

According to the conventional method for displaying performance patterns in wire frames, the performance image data using the wire frames is stored in a storing area in advance before the performance image data is displayed in sequence. Heavy use of performance images with such wire frames therefore needs a lot of storing area.

Now, take the case of switching one performance mode between a three-dimensional object with a wire frame and the other three-dimensional object without a wire frame. When the performance image is being created in the performance mode of the other three-dimensional object without a wire frame, it is not easily possible to switch the performance mode since the three-dimensional object with a wire frame needs to be created separately.

### SUMMARY OF THE INVENTION

It is thus an object of the present invention to provide a game machine, a display control method, and a display control program which can express a polygonal data object created from polygonal data in a three-dimensional virtual space by line drawing corresponding to a performance state.

To achieve the foregoing object, the invention according to claim 1 includes: a display device for displaying a three-dimensional performance image corresponding to a performance state provided by a game using a game medium; three-dimensional object storing means for storing a three-dimensional object generated from polygonal data that connects vertex coordinates in a three-dimensional virtual space; vertex coordinate extracting means for extracting the vertex coordinates of the polygonal data constituting the three-dimensional object stored in the three-dimensional object storing means; line drawing control means for performing a line drawing control on lines between the vertex coordinates of the polygonal data extracted by the vertex coordinate extracting means, on the basis of a performance condition corresponding to the performance state; drawing means for drawing the three-dimensional performance image on the basis of the three-dimensional object drawn by the line drawing control on lines is performed by the line drawing control means; and display control means for displaying and controlling the three-dimensional performance image drawn by the drawing means on the display device.

The invention according to claim 2 is the invention according to claim 1, further including vertex coordinate erase means for erasing part of the vertex coordinates of the polygonal data extracted by the vertex coordinate extracting means, and wherein the line drawing control means performs the drawing control on lines between the vertex coordinates that remain after the erasure of part of the vertex coordinates by the vertex coordinate erase means, on the basis of the performance condition corresponding to the performance state.

The invention according to claim 3 is the invention according to claim 2, further including vertex coordinate information storing means for storing vertex coordinate erase information that specifies vertex coordinates to be erased in association with the performance state among the vertex coordinates extracted by the vertex coordinate extracting means, and wherein the vertex coordinate erase means erases the vertex coordinates specified by the vertex coordinate erase information stored in the vertex coordinate information storing means.

The invention according to claim 4 is the invention according to any one of claims 1 to 3, wherein: the line drawing control means further includes line drawing means for drawing lines between adjoining vertex coordinates among the vertex coordinates of the polygonal data extracted by the vertex coordinate extracting means, and line delete means for deleting part of the lines of the three-dimensional object on the basis of the performance condition corresponding to the performance state, the lines being drawn between the vertex coordinates of the polygonal data by the line drawing means; and the drawing means draws the three-dimensional performance image on the basis of the three-dimensional object of which part of the lines between the vertex coordinates of the polygonal data are deleted by the line delete means.

The invention according to claim 5 is the invention according to claim 4, further including line drawing information storing means for storing line delete information that specifies lines to be deleted in association with the performance state among the lines on which the line drawing control is performed by the line drawing control means, and wherein the line delete means deletes the lines specified by the line delete information stored in the line drawing information storing means.

The invention according to claim 6 is the invention according to claim 4 or 5, wherein the line delete means deletes diagonal lines of rectangular data among the polygonal data on the three-dimensional object.

The invention according to claim 7 includes: three-dimensional object storing means for storing a three-dimensional object in association with a performance state provided by a game using a game medium, the three-dimensional object being generated from polygonal data that connects vertex coordinates in a three-dimensional virtual space; material image storing means for storing a material image that expresses an object surface of the three-dimensional object constituted by the polygonal data; line control means for performing a line control to draw lines on the material image stored in the material image storing means; and display control means for displaying and controlling a three-dimensional object whose outer shape is expressed by the lines when being in a predetermined performance state, by using the material image that results from the line control of the line control means on the polygonal data constituting the three-dimensional object stored in the three-dimensional object storing means.

The invention according to claim 8 is the invention according to claim. 7, wherein the line control means further includes mapping means for mapping the material image stored in the material image storing means onto the polygonal data constituting the three-dimensional object.

The invention according to claim 9 is the invention according to claim 8, further including specification means for specifying a plurality of pieces of polygonal data constituting the three-dimensional object, and wherein: the mapping means maps the material image stored in the material image storing means with the plurality of pieces of polygonal data specified by the specification means as a single unit; and the display control means displays and controls the three-dimensional object onto whose polygonal data the material image is mapped by the mapping means and whose outer shape is expressed by the lines.

The invention according to claim 10 is the invention according to claim 8, including generating means for generating a three-dimensional object by reducing the number of pieces of polygonal data constituting the three-dimensional object stored in the three-dimensional object storing means, and wherein the mapping means maps the material image stored in the material image storing means onto polygonal data on the three-dimensional object generated by the generating means.

The invention according to claim 11 is the invention according to any one of claims 7 to 10, wherein: the material image storing means stores a material image whose edge parts are hemmed with lines; and the display control means displays and controls the three-dimensional object onto whose polygonal data the material image is mapped.

The invention according to claim 12 is the invention according to any one of claims 7 to 10, wherein: the material image storing means stores a fully transparent material image; the line control means further includes line drawing means for drawing lines on edge parts of the material image stored in the material image storing means; and the display control means displays and controls the three-dimensional object onto whose polygonal data the material image is mapped, the material image having lines drawn on its edge parts by the line drawing means.

The invention according to claim 13 is the invention according to any one of claims 7 to 12, wherein the line control means further includes hidden line removal processing means for performing hidden line removal processing on the lines that hem edge parts of the polygonal data on the three-dimensional object, the edge parts being hidden when the three-dimensional object is displayed.

The invention according to claim 14 is the invention according to claim 13, wherein the hidden line removal processing means performs the hidden line removal processing on diagonal lines of rectangular polygon data if the polygonal data on the three-dimensional object includes the rectangular polygon data.

The invention according to claim 15 is the invention according to any one of claims 7 to 14, further including condition decision means for deciding whether there arises the performance state that satisfies a display condition of the three-dimensional object, and wherein the mapping means maps the material image when the condition decision means decides that the display condition is satisfied.

The invention according to claim 16 including: as three-dimensional object storing means, storing a three-dimensional object generated from polygonal data that connects vertex coordinates in a three-dimensional virtual space; as vertex coordinate extracting means, extracting the vertex coordinates of the polygonal data constituting the three-dimensional object stored in the three-dimensional object storing means; as control means, performing a line drawing control on lines between the vertex coordinates of the polygonal data extracted by the vertex coordinate extracting means, on the basis of a performance condition corresponding to a performance state; as drawing means, drawing the three-dimensional performance image on the basis of the three-dimensional object drawn by the line drawing control on lines is performed by the control means; and as display control means, displaying and controlling the three-dimensional performance image drawn by the drawing means on a display device.

The invention according to claim 17 includes: as three-dimensional object storing means, storing a three-dimensional object in association with a performance state provided by a game using a game medium, the three-dimensional object being generated from polygonal data that connects vertex coordinates in a three-dimensional virtual space; as material image storing means, storing a material image that expresses an object surface of the three-dimensional object constituted by the polygonal data; as line control means, performing a line control to draw lines on the material image stored in the material image storing means; and displaying and controlling the three-dimensional object whose outer shape is expressed by the lines when being in a predetermined performance state, by using the material image that results from the line control of the line control means on the polygonal data constituting the three-dimensional object stored in the three-dimensional object storing means.

The invention according to claim 18 causes a computer to function as: three-dimensional object storing means for storing a three-dimensional object generated from polygonal data that connects vertex coordinates in a three-dimensional virtual space; vertex coordinate extracting means for extracting the vertex coordinates of the polygonal data constituting the three-dimensional object stored in the three-dimensional object storing means; line drawing control means for performing a line drawing control on lines between the vertex coordinates of the polygonal data extracted by the vertex coordinate extracting means, on the basis of a performance condition corresponding to a performance state; drawing means for drawing the three-dimensional performance image on the basis of the three-dimensional object drawn by the line drawing control on lines is performed by the line drawing control means; and display control means for displaying and controlling the three-dimensional performance image drawn by the drawing means on a display device.

The invention according to claim 19 causes a computer to function as: three-dimensional object storing means for storing a three-dimensional object in association with a performance state provided by a game using a game medium, the three-dimensional object being generated from polygonal data that connects vertex coordinates in a three-dimensional virtual space; material image storing means for storing a material image that expresses an object surface of the three-dimensional object constituted by the polygonal data; line control means for performing a line control to draw lines on the material image stored in the material image storing means; and display control means for displaying and controlling a three-dimensional object whose outer shape is expressed by the lines when being in a predetermined performance state, by using the material image that results from the line control of the line control means on the polygonal data constituting the three-dimensional object stored in the three-dimensional object storing means.

According to the present invention, there is provided the effect that a polygonal data object created from polygonal data in a three-dimensional virtual space can be expressed by line drawing corresponding to the performance state.

### BRIEF DESCRIPTION OF THE DRAWINGS

FIG. 1 is a front view of a game machine which is configured through the application of the game machine, the display control method, and the display control program according to an embodiment of the present invention;

FIG. 2 is a perspective view of the game machine which is configured through the application of the game machine, the display control method, and the display control program according to the embodiment of the present invention, where a glass frame arranged on the front side is opened;

FIG. 3 is a perspective view of the back side of the game machine which is configured through the application of the game machine, the display control method, and the display control program according to the embodiment of the present invention;

FIG. 4 is a block diagram showing the detailed configuration of the entire game machine which is configured through the application of the game machine, the display control method, and the display control program according to the embodiment of the present invention;

FIG. 5 is a block diagram showing the detailed configuration of an image control board which constitutes the block diagram of the entire game machine shown in FIG. 4;

FIG. 6 is a diagram showing the detailed configuration of a display control unit which is configured through the application of the game machine, the display control method, and the display control program according to the present invention;

FIG. 7 is a block diagram showing the detailed configuration of a line drawing control processing unit shown in FIG. 6;

FIG. 8 is a block diagram showing the detailed configuration of the line drawing control processing unit shown in FIG. 6;

FIG. 9 is a flowchart showing the detailed procedure of main processing to be performed by a main control board which constitutes the block diagram of the entire game machine shown in FIG. 4;

FIG. 10 is a flowchart showing the detailed procedure of timer interrupt processing to be performed by the main control board which constitutes the block diagram of the entire game machine shown in FIG. 4;

FIG. 11 is a flowchart showing the detailed procedure of special symbol special electric control processing to be performed by the main control board which constitutes the block diagram of the entire game machine shown in FIG. 4;

FIG. 12 is a flowchart showing the detailed procedure of special symbol storing and judgment processing to be performed by the main control board which constitutes the block diagram of the entire game machine shown in FIG. 4;

FIG. 13 is a flowchart showing the detailed procedure of main processing to be performed by a performance control board which constitutes the block diagram of the entire game machine shown in FIG. 4;

FIG. 14 is a flowchart showing the detailed procedure of timer interrupt processing to be performed by the performance control board which constitutes the block diagram of the entire game machine shown in FIG. 4;

FIG. 15 is a flowchart showing the detailed procedure of command analysis processing to be performed by the performance control board which constitutes the block diagram of the entire game machine shown in FIG. 4;

FIG. 16 is a flowchart showing the detailed procedure continued from that of the command analysis processing to be performed by the performance control board shown in FIG. 15;

FIG. 17 is a flowchart showing the detailed procedure of display control processing to be performed by the display control unit which is configured through the application of the game machine, the display control method, and the display control program according to the embodiment of the present invention;

FIG. 18 is another example of the flowchart showing the detailed procedure of the display control processing to be performed by the display control unit which is configured through the application of the game machine, the display control method, and the display control program according to the embodiment of the present invention;

FIG. 19 is a flowchart showing the detailed procedure of line drawing control processing which is shown in the flowcharts of FIGS. 17 and 18;

FIG. 20 is a flowchart showing the detailed procedure of the line drawing control processing which is shown in the flowcharts of FIGS. 17 and 18;

FIGS. 21A to 21D are diagrams showing an example of a three-dimensional object in a predetermined mode, formed by the display control processing to be performed by the display control unit which is configured through the application of the game machine, the display control method, and the display control program according to the embodiment of the present invention;

FIG. 22 is a block diagram showing the detailed configuration of the display control unit which is included in an image control unit (VDP) which constitutes the image control board shown in FIG. 5;

FIG. 23 is a block diagram showing the detailed configuration of a texture control processing unit shown in FIG. 6;

FIGS. 24A and 24B are diagrams showing the mapping of a texture on each polygon of a three-dimensional object;

FIG. 25 is a flowchart showing the procedure of the processing to be performed by the display control unit of the game machine which is configured through the application of the game machine, the display control method, and the display control program according to the embodiment of the present invention;

FIG. 26 is a flowchart showing the detailed procedure of “texture control processing” that is included in the flowchart of FIG. 17;

FIGS. 27A to 27C are diagrams showing a three-dimensional object on which a texture is mapped after polygon reduction processing; and

FIGS. 28A to 28C are diagrams showing the mapping of a texture with a plurality of polygons as a single unit.

### DETAILED DESCRIPTION OF THE PREFERRED EMBODIMENT

Hereinafter, an embodiment of the game machine, the display control method, and the display control program according to the present invention will be described in detail with reference to the accompanying drawings.

### Embodiment

### Practical Example 1

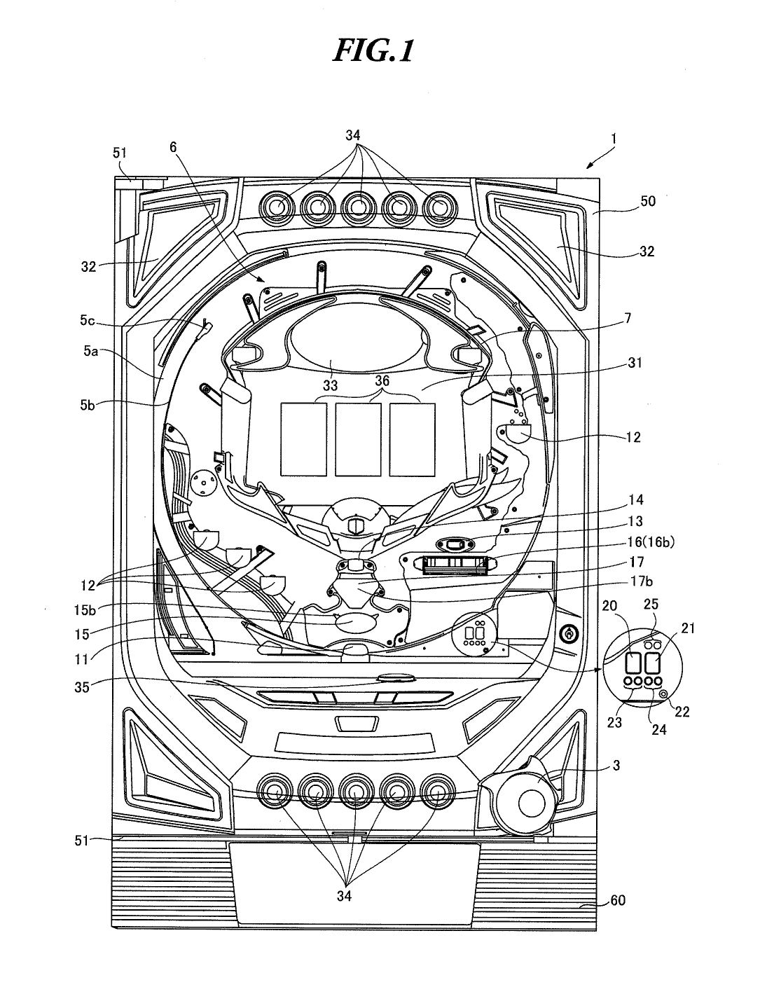

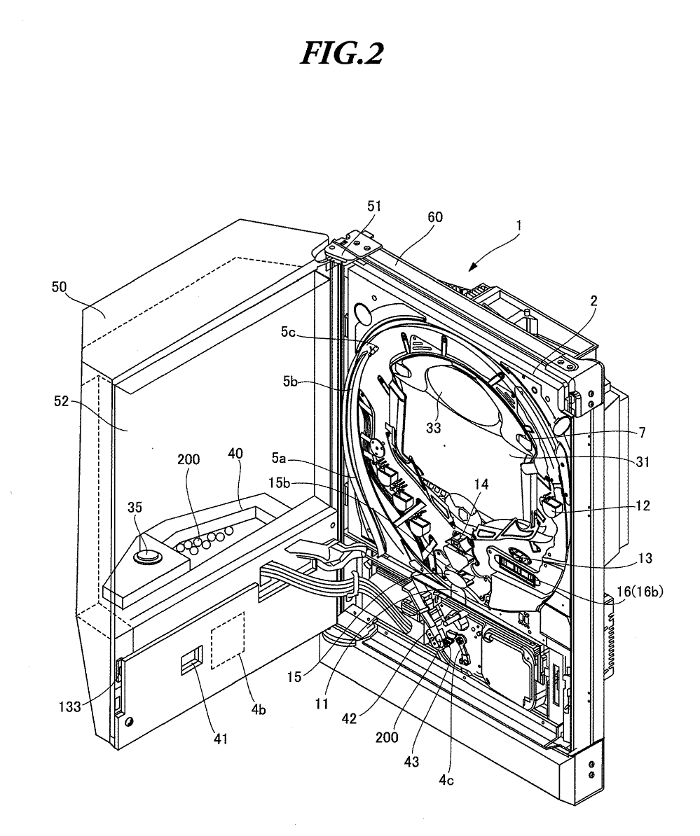

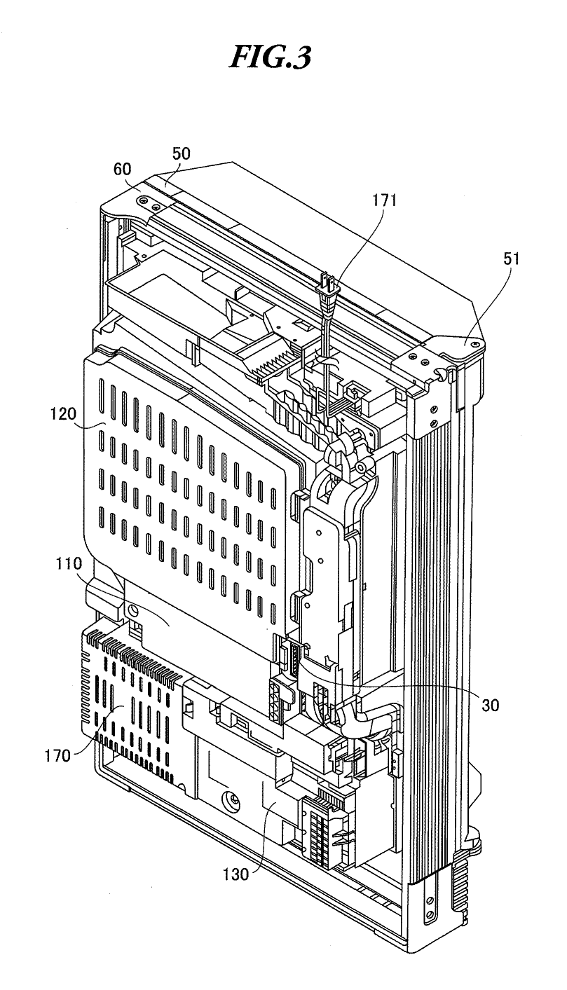

FIG. 1 is an example of an apparatus configuration diagram showing a game machine that is configured through the application of the game machine, the display control method, and the display control program according to the embodiment of the present invention. FIG. 2 is a perspective view of the game machine 1 according to the present invention where a glass frame is opened. FIG. 3 is a perspective view of the back side of one game machine 1.

While the diagrams deal with a pachinco machine as an example of the game machine, the game machine is not limited thereto and may be implemented as a slot machine. When the game machine is implemented as a slot machine, medals are used as game media.

The game machine 1 includes an outer frame 60 which is attached to island facilities in a game parlor, and a glass frame 50 which is rotatably supported by the outer frame 60 (see FIGS. 1 and 2). The outer frame 60 is equipped with a game panel 2 which has a game field 6 for game balls to cascade down. The glass frame 50 is provided with: an operating handle 3 which is rotationally operated to shoot game balls toward the game field 6; sound output devices 32 which are composed of speakers; performance illumination devices 34 which include a plurality of lamps; and a performance button 35 which is intended to change a performance mode by a depressing operation.

The glass frame 50 also has a tray 40 for storing a plurality of game balls. The tray 40 is inclined downward so that game balls flow down toward the operating handle 3 (see FIG. 2). An inlet port for accepting game balls is formed at the end of inclination of the tray 40. Game balls taken into the inlet port are driven by a ball feed solenoid 4b and sent to a ball feed opening 41 formed in the back side of the glass frame 50 one by one.

The game ball sent to the ball feed opening 41 is guided through a shoot rail 42, which is inclined toward a flipper member 4c, to the end of inclination of the shoot rail 42. A stopper 43 for stopping and retaining a game ball is arranged above the end of inclination of the shoot rail 42. A single game ball sent from the ball feed opening 41 is stopped and retained at the end of inclination of the shoot rail 42 (see FIG. 2).

When the player rotates the operating handle 3, a shoot volume 3b directly connected to the operating handle 3 is also rotated. The shoot volume 3b adjusts the shooting strength of the game ball, and the flipper member 4c which is directly connected to a shooting solenoid 4a is rotated by the adjusted shooting strength. When the flipper member 4c is rotated, the flipper member 4c shoots off the game ball stored at the end of inclination of the shoot rail 42, and the game ball is shot into the game field 6.

The game ball shot from the shoot rail 42 as described above ascends between rails 5a and 5b, passes a backflow prevention piece 5c to reach the game field 6, and then cascades down within the game field 6. Here, the game ball falls in an unpredictable manner because of a plurality of pins and pinwheels arranged on the game field 6.

A plurality of general prize holes 12 are formed in the game field 6. The general prize holes 12 are provided with respective general prize hole detection switches 12a. When the general prize hole detection switches 12a detect the entry of a game ball, predetermined winning balls (for example, ten game balls) are dispensed.

A first start hole 14, a second start hole 15, and a second bonus prize hole 17 are formed in the lower central area of the game field 6. The first start hole 14 and the second start hole 15 constitute start areas which game balls can enter. The second bonus prize hole 17 also allows the entry of game balls.

The second start hole 15 has a pair of movable pieces 15b. The second start hole 15 is motion-controlled between a first mode where the pair of movable pieces 15b are maintained in a closed state and a second mode where the pair of movable pieces 15b are in an open state. When the second start hole 15 is controlled to the first mode, the winning members of the second bonus prize hole 17 arranged directly above the second start hole 15 function as an obstacle to the acceptance of game balls.

On the other hand, when the second start hole 15 is controlled to the second mode, the pair of movable pieces 15b function as a tray, facilitating the entry of game balls into the second start hole 15. That is, if the second start hole 15 is in the first mode, there is no chance for game balls to enter. If the second start hole 15 is in the second mode, there is a higher chance for game balls to enter.

Here, the first start hole 14 is provided with a first start hole detection switch 14a which detects the entry of a game ball. The second start hole 15 is provided with a second start hole detection switch 15a which detects the entry of a game ball. When the first, start hole detection switch 14a or the second start hole detection switch 15a detects the entry of a game ball, a special symbol judgment random number value and the like are acquired to perform drawing for the right to play a jackpot game to be described later (hereinafter, referred to as “jackpot drawing”).

Predetermined winning balls (for example, three game balls) are also dispensed when the first start hole detection switch 14a or the second start hole detection switch 15a detects the entry of a game ball.

The second bonus prize hole 17 includes an opening formed in the game panel 2. The second bonus prize hole 17 has on its lower part a second bonus prize hole opening and closing door 17b which can be protruded from the game panel side toward a glass plate 52. The second bonus prize hole opening and closing door 17b is motion-controlled between an open state of being protruded from the game panel side and a closed state of sinking into the game panel side.

When protruded from the game panel side, the second bonus prize hole opening and closing door 17b functions as a tray that guides game balls into the second bonus prize hole 17, so that game balls can enter the second bonus prize hole 17. The second bonus prize hole 17 is provided with a second bonus prize hole detection switch 17a. When the second bonus prize hole detection switch 17a detects the entry of a game ball, predetermined winning balls (for example, 15 game balls) are dispensed.

A normal symbol gate 13 which constitutes a normal area where game balls can pass and a first bonus prize hole 16 which game balls can enter are formed in the right area of the game field 6.

Such a configuration prevents game balls from passing or entering the normal symbol gate 13 or the first bonus prize hole 16 unless the operating handle 3 is largely rotated to launch the game balls by strong force.

In particular, with such a configuration, game balls cascading down the left area of the game field 6 will not pass the normal symbol gate 13 even in a Jitan (quick) game state to be described later. Since the pair of movable pieces 15b on the second start hole 15 will not enter the open state, it is difficult for game balls to enter the second start hole 15.

The normal symbol gate 13 is provided with a gate detection switch 13a which detects the passage of a game ball. When the gate detection switch 13a detects the passage of a game ball, a normal symbol judgment random number value is acquired to perform “normal symbol drawing” to be described later.

The first bonus prize hole 16 is usually maintained in the closed state by a first bonus prize hole opening and closing door 16b, thereby precluding the entry of game balls. When a special game to be described later is started, the first bonus prize hole opening and closing door 16b is opened. The first bonus prize hole opening and closing door 16b functions as a tray that guides game balls into the first bonus prize hole 16, so that game balls can enter the first bonus prize hole 16. The first bonus prize hole 16 is provided with a first bonus prize hole detection switch 16a. When the first bonus prize hole detection switch 16a detects the entry of a game ball, predetermined winning balls (for example, 15 game balls) are dispensed.

An out hole 11 is formed in the bottom area of the game field 6, at the bottom of the game field 6. The out hole 11 is intended to drain game balls that fail to enter any of the general prize holes 12, the first start hole 14, the second start hole 15, the first bonus prize hole 16, and the second bonus prize hole 17.

A decoration member 7 which has an influence on the cascading of game balls is provided in the center of the game field 6. A liquid crystal display (LCD) 31 is arranged generally in the center area of the decoration member 7. A belt-shaped performance drive device 33 is arranged above the liquid crystal display 31.

The liquid crystal display 31 displays images on standby when no game is being played, or displays images according to the progress of a game. In particular, the liquid crystal display 31 displays three performance symbols 36 for notifying the result of jackpot drawing to be described later. A certain combination of performance symbols 36 (such as 777) remains to be displayed to notify of hitting a jackpot as the result of jackpot drawing.

More specifically, when a game ball enters the first start hole 14 or the second start hole 15, each of the three performance symbols 36 is scrolled. After a lapse of predetermined time, each of them stopped scrolling is stopped to display the performance symbols 36. While the display of the performance symbols 36 is changing, a variety of images, characters, and the like are displayed in order to give the player a sense of high anticipation of hitting a jackpot.

The performance drive device 33 is intended to give the player a sense of anticipation by means of its operating mode. For example, the performance drive device 33 makes an operation such that the belt moves downward, or a rotating member rotates in the belt center. Such modes of operation of the performance drive device 33 are intended to give the player various feelings of anticipation.

In addition to the various types of performance devices described above, the sound output devices 32 enables audio performance by outputting the characters' voice, background music (BGM), sound effects (SE), and the like. The performance illumination devices 34 change the direction of light projection and the color of each lamp for illumination-based performances.

The performance button 35 is enabled, for example, only when a message to operate the performance button 35 appears on the liquid crystal display 31. The performance button 35 is provided with a performance button detection switch 35a. When the performance button detection switch 35a detects the player's operation, an additional performance is executed according to the operation.

A first special symbol display device 20, a second special symbol display device 21, a normal symbol display device 22, a first special symbol reservation indicator 23, a second special symbol reservation indicator 24, and a normal symbol reservation indicator 25 are arranged on the lower right of the game field 6.

The first special symbol display device 20 is intended to notify of the result of jackpot drawing that is performed when a game ball enters the first start hole 14. The first special symbol display device 20 is composed of a 7-segment LED. More specifically, there are provided a plurality of special symbols corresponding to results of jackpot drawing. The first special symbol display device 20 displays a special symbol corresponding to a result of jackpot drawing, thereby notifying the player of the result of drawing. For example, “7” appears when a jackpot is hit, and “-” appears when not. Such “7” and “-” displayed are the special symbols. The special symbols are not immediately displayed, but are stopped and displayed after showing variations for a predetermined time.

Here, the “jackpot drawing” refers to the processing of acquiring a special symbol judgment random number value and judging whether the special symbol judgment random number value acquired is the one corresponding to a “jackpot” or the one corresponding to a “small jackpot” when a game ball enters the first start hole 14 or the second start hole 15. The result of jackpot drawing is not immediately notified to the player. The first special symbol display device 20 displays the special symbol with variations such as blinking, and after a lapse of a predetermined variation time, the special symbol corresponding to the result of jackpot drawing without variations displayed still to notify the player of the result of drawing.

The second special symbol display device 21 is intended to notify of the result of jackpot drawing that is performed when a game ball enters the second start hole 15. The display mode is the same as that of the special symbols on the first special symbol display device 20.

In the present embodiment, the “jackpot” refers to winning the right to play a jackpot game in the jackpot drawing that is performed when a game ball enters the first start hole 14 or the second start hole 15. In the “jackpot game,” a total of 15 round games are played where the first bonus prize hole 16 or the second bonus prize hole 17 is opened up. The maximum open time of the first bonus prize hole 16 or the second bonus prize hole 17 in each round game is set to a predetermined time. A single round game ends if a predetermined number of game balls (for example, nine) enter the first bonus prize hole 16 or the second bonus prize hole 17 during that period.

That is, in the “jackpot game,” game balls enter the first bonus prize hole 16 or the second bonus prize hole 17 and the player can win balls according to the entering balls.

The normal symbol display device 22 is intended to notify the result of normal symbol drawing which is performed when a game ball passes the normal symbol gate 13. As will be detailed later, the normal symbol display device 22 is lit when hitting a win in the normal symbol drawing. The second start hole 15 is then controlled to the second mode for a predetermined time.

Here, the “normal symbol drawing” refers to the processing of acquiring a normal symbol judgment random number value and determining whether the normal symbol judgment random number value acquired is one corresponding to “winning” when a game ball passes the normal symbol gate 13. Again, the result of normal symbol drawing is not notified immediately after a game ball passes the normal symbol gate 13. The normal symbol display device 22 displays the normal symbol with variations such as blinking, and after a lapse of a predetermined variation time, the normal symbol corresponding to the result of normal symbol drawing is displayed without variations to notify the player of the result of drawing.

The right for jackpot drawing is reserved under a certain condition when a game ball entering the first start hole 14 or the second start hole 15 unable to perform jackpot drawing immediately, such as during a special symbol is being displayed with variations and when during a special game as described later.

More specifically, the special symbol judgment random number value that is acquired when a game ball enters the first start hole 14 is stored as a first reservation. The special symbol judgment random number value that is acquired when a game ball enters the second start hole 15 is stored as a second reservation.

The maximum number of each reservation is set to four. The numbers of reservations are displayed on the first special symbol reservation indicator 23 and the second special symbol reservation indicator 24, respectively.

If there is one first reservation, the left LED of the first special symbol reservation indicator 23 is lit. If there are two first reservations, the two LEDs of the first special symbol reservation indicator 23 are lit. If there are three first reservations, the left LED of the first special symbol reservation indicator 23 is blinked and the right LED is lit. If there are four first reservations, the two LEDs of the first special symbol reservation indicator 23 are blinked.

The second special symbol reservation indicator 24 displays the number of second reservations as mentioned in the first special symbol reservation.

The maximum number of normal symbol reservations is also set to four. The number of reservations is displayed on the normal symbol reservation indicator 25 in the same way as with the first special symbol reservation indicator 23 and the second special symbol reservation indicator 24.

The glass frame 50 supports the glass plate 52 in front (player side) of the game panel 2. The game field 6 is visibly covered with the glass plate 52. The glass plate 52 is detachably fixed to the glass frame 50.

The glass frame 50 is coupled to the outer frame 60 via hinge mechanism parts 51 on either one of the lateral sides (for example, the left side when the game machine 1 is viewed from the front). The glass frame 50 is configured so that the other lateral side (for example, the right side when the game machine 1 is viewed from the front) can be rotated about the hinge mechanism parts 51 in an opening direction from the outer frame 60. The glass frame 50 covers the game panel 2 along with the glass plate 52, and can be rotated about the hinge mechanism parts 51 in a door-like manner, thereby the interior of the outer frame 60 including the game panel 2 can be exposed.

The other end of the glass frame 50 is provided with a lock mechanism which fixes the other end of the glass frame 50 to the outer frame 60. The fixing of the lock mechanism can be released by a dedicated key. The glass frame 50 is provided with a door open switch 133 which detects whether the glass frame 50 is opened from the outer frame 60.

As shown in FIG. 3, a main control board 110, a performance control board 120, a dispensing control board 130, a power supply board 170, a game information output terminal strip 30, and the like are arranged on the back side of the game machine 1. The power supply board 170 has a power plug 171 for supplying power to the game machine 1, and a not-shown power supply switch.

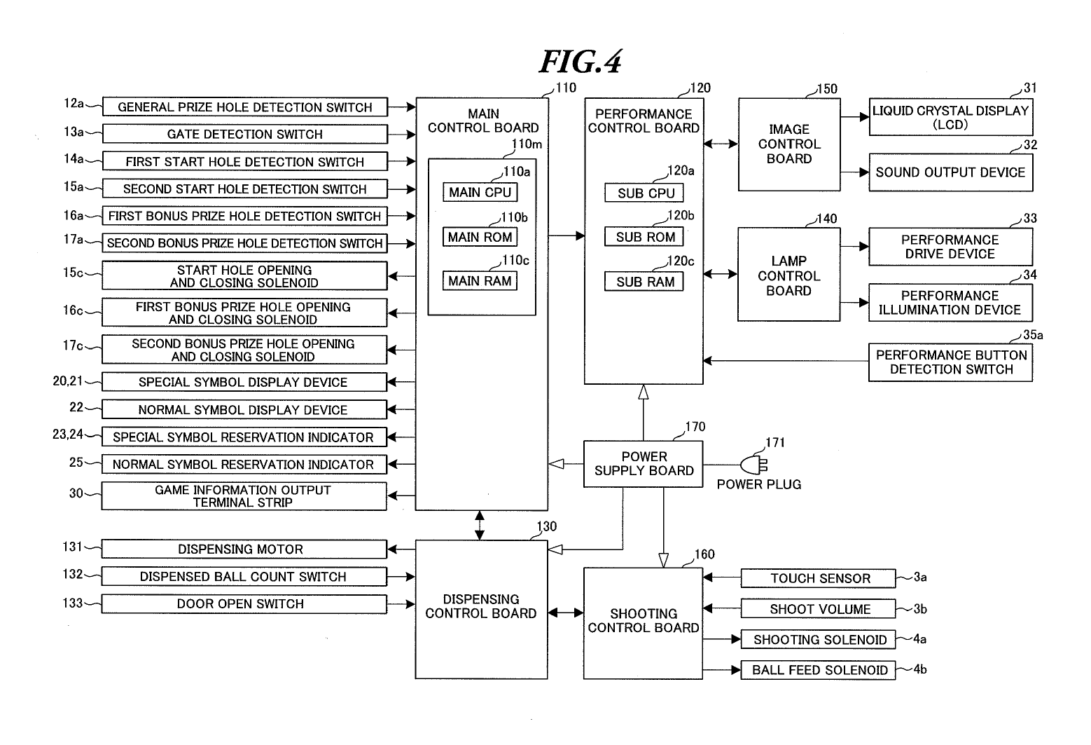

Next, control means for controlling the game progress will be described with reference to a block diagram of the entire game machine 1 of FIG. 4.

The main control board 110 is main control means for controlling basic operations of the game. The main control board 110 drives the first special symbol display device 20, a first bonus prize hole opening and closing solenoid 16c, and the like for game control, when various types of detection signals are input from the first start hole detection switch 14a and the like.

The main control board 110 includes at least a one-chip microcomputer 110m which is composed of a main CPU 110a, a main ROM 110b, and a main RAM 110c, and input ports and output ports (not shown) for main control.

The input ports for main control are connected to: the dispensing control board 130; the general prize hole detection switches 12a which detect the entry of a game ball into the general prize holes 12; the gate detection switch 13a which detects the entry of a game ball into the normal symbol gate 13; the first start hole detection switch 14a which detects the entry of a game ball into the first start hole 14; the second start hole detection switch 15a which detects the entry of a game ball into the second start hole 15; the first bonus prize hole detection switch 16a which detects the entry of a game ball into the first bonus prize hole 16; and the second bonus prize hole detection switch 17a which detects the entry of a game ball into the second bonus prize hole 17. Various signals are input to the main control board 110 through the input ports for main control.

The output ports for main control are connected to: the dispensing control board 130; a start hole opening and closing solenoid 15c which operates to open and close the pair of movable pieces 15b on the second start hole 15; the first bonus prize hole opening and closing solenoid 16c which operates the first bonus prize hole opening and closing door 16b; a second bonus prize hole opening and closing solenoid 17c which operates the second bonus prize hole opening and closing door 17b; the first special symbol display device 20 and the second special symbol display device 21 which display special symbols; the normal symbol display device 22 which displays a normal symbol; the first special symbol reservation indicator 23 and the second special symbol reservation indicator 24 which indicate the numbers of balls reserved for special symbols; the normal symbol reservation indicator 25 which indicates the number of balls reserved for normal symbols; and the game information output terminal strip 30 which outputs external information signals. Various signals are output through the output ports for main control.

The main CPU 110a loads a program stored in the main ROM 110b and performs arithmetic processing on the basis of the input signals from the detection switches and timers. The main CPU 110a also controls the devices and indicators directly, and transmits commands to other boards depending on the result of arithmetic processing.

The main ROM 110b of the main control board 110 stores programs for game control, and data and tables necessary for making various game determinations. For example, the main ROM 110b stores: a jackpot judgment table referenced for jackpot drawing; a winning judgment table referenced for normal symbol drawing; a symbol determination table which determines the special symbols to be stopped at; a jackpot game end time setting data table for determining the game state after the end of a jackpot; a special electrical gadget start mode determination table which determines the opening and closing conditions of the bonus prize hole opening and closing doors; a bonus prize hole open mode table; a variation pattern determination table to determine the variation pattern of the special symbols; and so on.

The tables mentioned above are just a few examples of characteristic tables among the tables according to the present embodiments. A lot of other not-shown tables and programs are provided for game progresses.

The main RAM 110c of the main control board 110 functions as a data work area in the arithmetic processing of the main CPU 110a, and includes a plurality of storing areas.

For example, the main RAM 110c has a normal symbol reserved number (G) storing area, a normal symbol reservation storing area, a normal symbol data storing area, a first special symbol reserved number (U1) storing area, a second special symbol reserved number (U2) storing area, a first special symbol random number value storing area, a second special symbol random number value storing area, a round game number (R) storing area, an open number (K) storing area, a bonus prize hole entering ball number (C) storing area, a game state storing area (a high probability game flag storing area and a quick game flag storing area), a high probability game number (X) counter, a quick number (J) counter, a game state buffer, a stop symbol data storing area, a performance transmission data storage area, a special symbol time counter, a special game timer counter, and various other timer counters. The storing areas mentioned above are just a few examples, and there are provided a lot of other storing areas are provided.

The game information output terminal strip 30 is a substrate for outputting the external information signals generated by the main control board 110 to a hall computer or the like of the game parlor. The game information output terminal strip 30 is wired and connected to the main control board 110, and has connectors for connecting to the hall computer or the like in the game parlor, which transmits and receives external information.

The power supply board 170 includes a capacitor-based backup power supply, and supplies a power supply voltage to the game machine 1. The power supply board 170 monitors the power supply voltage supplied to the game machine 1, and if the power supply voltage falls to a predetermined value and below, outputs an electricity disconnection detection signal to the main control board 110. More specifically, the electricity disconnection detection signal of high level activates the main CPU 110a. The electricity disconnection detection signal of low level deactivates the main CPU 110a. The backup power supply is not limited to the capacitor. For example, a battery may be used. Both of the capacitor and the battery may be used.

The performance control board 120 mainly controls performances during a game, on standby, and the like. The performance control board 120 includes a sub CPU 120a, a sub ROM 120b, and a sub RAM 120c. The performance control board 120 is connected with the main control board 110 to allow one-way communication from the main control board 110 to the performance control board 120. The sub CPU 120a loads a program stored in the sub ROM 120b and performs arithmetic processing on the basis of a command transmitted from the main control board 110, or an input signal from the performance button detection switch 35a or a timer. On the basis of the processing, the sub CPU 120a transmits corresponding data to the lamp control board 140 or the image control board 150. The sub RAM 120c functions as a data work area in the arithmetic processing of the sub CPU 120a.

For example, the sub CPU 120a of the performance control board 120 receives a variation pattern specification command which specifies the mode of variation of the special symbols from the main control board 110. Then, the sub CPU 120a analyzes the content of the variation pattern specification command received, and generates data for making the liquid crystal display 31, the sound output devices 32, the performance drive device 33, and the performance illumination devices 34 provide a predetermined performance. The sub CPU 120a transmits the data to the image control board 150 and the lamp control board 140.

The sub ROM 120b of the performance control board 120 stores programs for performance control, and data and tables necessary for making various game determinations.

For example, the sub ROM 120b stores a performance pattern determination table for determining a performance pattern on the basis of the variation pattern specification command received from the main control board, a performance symbol determination table for determining the combination of performance images 36 to remain to be displayed, and the like.

The tables mentioned above are just a few examples of characteristic tables among the tables according to the present embodiment. A lot of other not-shown tables and programs are provided for game progress.

The sub RAM 120c of the performance control board 120 functions as a data work area in the arithmetic processing of the sub CPU 120a, and includes a plurality of storing areas.

The sub RAM 120c has a game state storing area, a performance mode storing area, a performance pattern storing area, a performance symbol storing area, and the like. The storing areas mentioned above are just a few examples, and there are provided a lot of other storing areas are provided.

The dispensing control board 130 performs a dispensing control on game balls. The dispensing control board 130 includes a one-chip microcomputer that is composed of a not-shown dispensing CPU, dispensing ROM, and dispensing RAM. The dispensing control board 130 is connected to the main control board 110 so as to be capable of two-way communications. The dispensing CPU loads a program stored in the dispensing ROM and performs arithmetic processing on the basis of input signals from a dispensed ball count detection switch 132 which detects whether game balls are dispensed, the door open switch 133, and timers. On the basis of the processing, the dispensing CPU transmits corresponding data to the main control board 110.

A dispensing motor 131 of a dispensing device for dispensing a predetermined number of game balls from the game ball reservoir is connected to the output side of the dispensing control board 130. On the basis of a dispensing number specification command transmitted from the main control board 110, the dispensing CPU loads a predetermined program from the dispensing ROM, performs arithmetic processing, and controls the dispensing motor 131 of the dispensing device to dispense predetermined game balls.

Here, the dispensing RAM functions as a data work area in the arithmetic processing of the dispensing CPU.

The lamp control board 140 performs alighting control on the performance illumination devices 34 arranged on the game panel 2, and performed a drive control on motors for changing the directions of light projection. The lamp control board 140 also performs an energization control on drive sources such as solenoids and motors that actuate the performance drive device 33. The lamp control board 140 is connected to the performance control board 120, and performs the foregoing controls on the basis of various commands transmitted from the performance control board 120.

The image control board 150 is connected to the liquid crystal display 31 and the sound output devices 32.

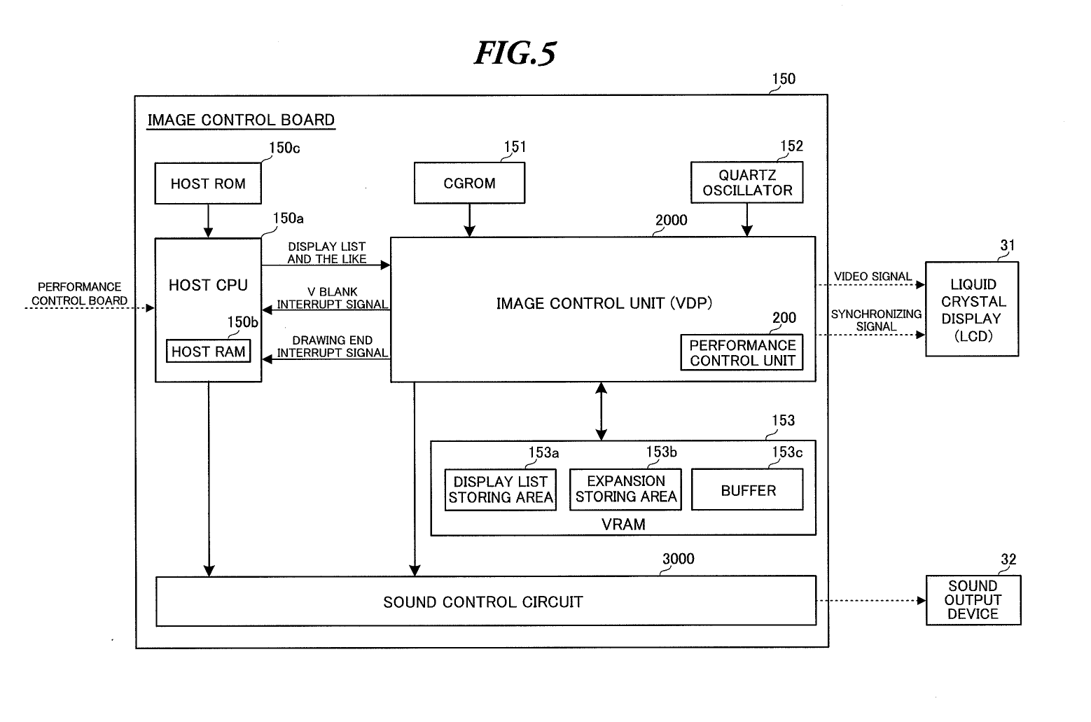

On the basis of various commands transmitted from the performance control board 120, the image control board 150 controls an image display on the liquid crystal display 31 and a sound output on the sound output devices 32. The image control board 150 will be detailed below with reference to a block diagram of the image control board of FIG. 5.

The image display control will now be described with reference to the block diagram of the image control board 150 of FIG. 5.

The image control board 150 includes a host CPU 150a, a host RAM 150b, a host ROM 150c, a CG ROM 151, a quartz oscillator 152, a VRAM 153, and a VDP (Video Display Processor) 2000 which are intended for the image display control on the liquid crystal display 31, and a sound control circuit 3000.

The host CPU 150a having a performance control unit 200 instructs the VDP 2000 to display image data stored in the CG ROM 151 on the liquid crystal display 31 based on a performance pattern specification command received from the performance control board. Such an instruction is given by setting data into control registers of the VDP 2000 and outputting a display list including a group of drawing control commands.

On receiving a V blank interrupt signal or a drawing end signal from the VDP 2000, the host CPU 150a performs interrupt processing if necessary.

On the basis of the performance pattern specification command received from the performance control board 120, the host CPU 150a also instructs the sound control circuit 3000 to make the sound output devices 32 output predetermined sound data.

The host RAM 150b that is built in the host CPU 150a functions as a data work area in the arithmetic processing of the host CPU 150a, and temporarily stores data that is read from the host ROM 150c.

The host ROM 150c that is made of a mask ROM stores programs for the control processing of the host CPU 150a, a display list generation program for generating a display list, an animation pattern for displaying an animated performance pattern, animation information, and so on.

The animation pattern is referenced when displaying the animated performance pattern. The animation pattern stores a combination of pieces of animation scene information to be included in the performance pattern, the order of display of the pieces of animation scene information, and the like.

The animation scene information includes such information as wait frame (display time), target data (sprite ID number, transmission source address, and the like), parameters (sprite display position, transmission destination address, and the like), and the method of drawing.

The CG ROM 151 that is constituted by a flash memory, EEPROM, EPROM, mask ROM, or the like. The CG ROM 151 stores compressed image data (sprite or movie) and so on which includes pixel information on a predetermined area of pixels (for example, 32×32 pixels), as well as three-dimensional objects and the like. The pixel information is composed of color number information that specifies a color number for each individual pixel, and an a value that indicates the transparency of the image. The three-dimensional objects will be described later.

The CG ROM 151 further stores uncompressed palette data which associates color number information for specifying color numbers with display color information for actual color display.

It should be appreciated that the CG ROM 151 may be configured to compress only part of the image data, not the entire image data. Various known compression methods such as MPEG-4 may be used for the movie compression.

The quartz oscillator 152 outputs a pulsed signal to the VDP 2000 (clock generation circuit). The pulsed signal is frequency-divided for the clock generation circuit to generate a system clock for the VDP 2000 to use for control, synchronizing signals intended for synchronization with the liquid crystal display 31, and the like.

The VRAM 153 is made of an SRAM which is capable of writing and reading image data at high speed.

The VRAM 153 includes: a display list storing area 153a which temporarily stores a display list that is output from the host CPU 150a; a decompression storing area 153b which stores image data that is decompressed by a decompression circuit; and a first frame buffer 153c and a second frame buffer 153d which are intended to draw or display an image. The VRAM 153 also stores the palette data.

The two frame buffers are switched between a “drawing frame buffer” and a “display frame buffer” alternately each time drawing is started.

The VDP 2000 is a so-called image processor. The VDP 2000 reads image data from either one of the frame buffers (display frame buffer) on the basis of an instruction from the host CPU 150a, and generates a video signal (such as RGB signal) and outputs the same to the liquid crystal display on the basis of the read image data.

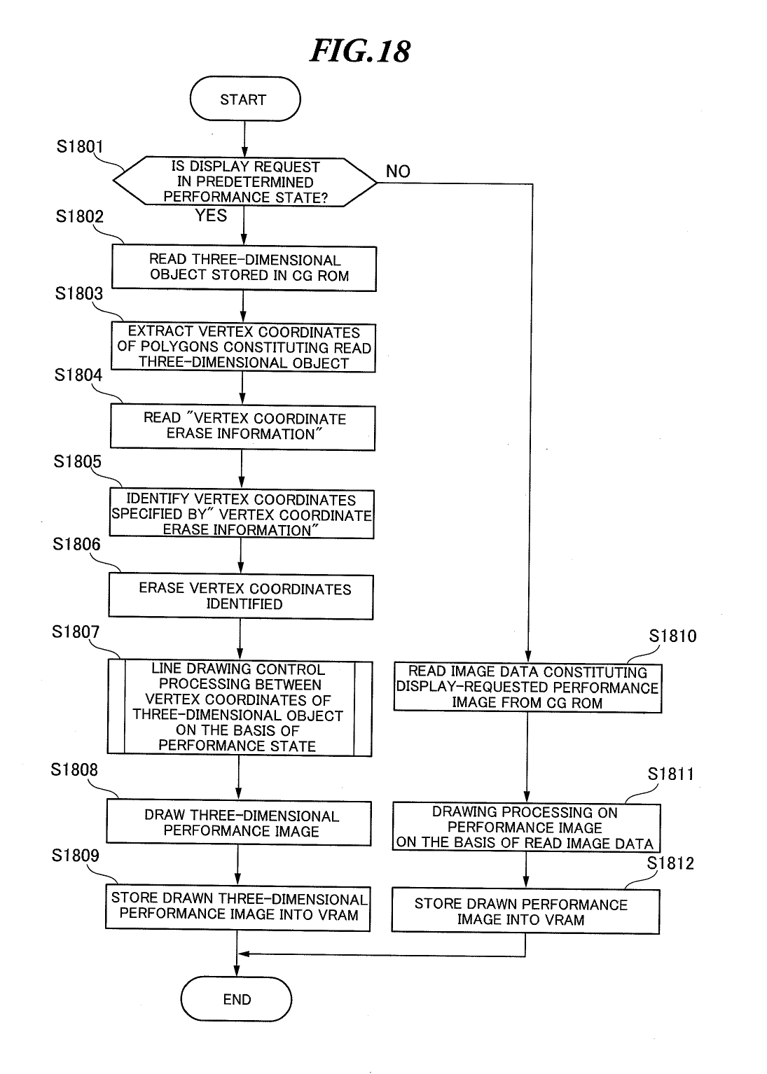

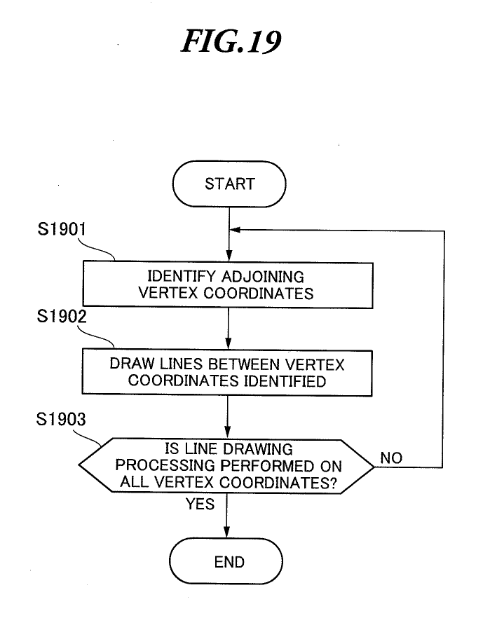

Aside from the display control unit 200, the VDP 2000 includes not-shown control registers, a CG bus I/F, a CPU I/F, a clock generation circuit, a decompression circuit, a drawing circuit, a display circuit, and a memory controller, which are connected by a bus. The procedure of the processing to be performed by the display control unit 200 is shown in FIGS. 18 and 19, which will be described later.

The control registers are registers intended for the VDP 2000 to perform drawing and display control with. The drawing control and display control are performed by writing and reading data to/from the control registers. The host CPU 150a can write and read data to/from the control registers through the CPU I/F.

The control registers are composed of six types of registers, including: a system control register for making basic settings necessary for the operation of the VDP 2000; a data transfer register for making a setting necessary for data transfer; a drawing register for making a setting for drawing control; a bus interface register for making a setting necessary for bus access; a decompression register for making a setting necessary for the decompression of a compressed image; and a display register for making a setting for display control.

The CG bus I/F is an interface circuit for communication with the CG ROM 151. The image data from the CG ROM 151 is input to the VDP 2000 through the CG bus I/F.

The CPU I/F is an interface circuit for communication with the host CPU 150a. The host CPU 150a outputs a display list to the VDP 2000, accesses the control registers, and inputs various interrupt signals from the VDP 2000 through the CPU I/F.

The data transfer circuit performs data transfer between various types of devices.

Specifically, the data transfer circuit performs data transfer between the host CUP 150a and the VRAM 153, data transfer between the CG ROM 151 and the VRAM 153, and mutual data transfer between various storing areas of the VRAM 153 (including the frame buffers).

The clock generation circuit inputs the pulsed signal from the quartz oscillator 152, and generates the system clock which determines the arithmetic processing speed of the VDP 2000. The clock generation circuit also generates a synchronizing signal generating clock, and outputs synchronizing signals to the liquid crystal display 31 through the display circuit.

The decompression circuit is a circuit for decompressing the compressed image data in the CG ROM 151. The decompression circuit stores the decompressed image data into the expansion storing area 153b.

The drawing circuit is a circuit for performing a sequence control based on a display list which is composed of a group of drawing control commands.

The display circuit is a circuit that generates a video signal, or an RGB signal (analog signal) which shows color data on the image, from the image data (digital signal) stored in the “display frame buffer” of the VRAM 153. The display circuit outputs the generated video signal (RGB signal) to the liquid crystal display 31. The display circuit also outputs the synchronizing signals intended for synchronization with the liquid crystal display 31 (such as a vertical synchronizing signal and a horizontal synchronizing signal) to the liquid crystal display 31.

In the present embodiment, the analog RGB signal converted from the digital signal is output to the liquid crystal display 31 as the video signal. However, the digital signal itself may be output as the video signal.

The memory controller performs control to switch between the “drawing frame buffer” and the “display frame buffer” when an instruction for frame buffer switching is given from the host CPU 150a.

The sound control circuit 3000 includes a voice ROM which stores a lot of voice data. The sound control circuit 3000 reads a predetermined program on the basis of a command transmitted from the performance control board 120, and performs voice output control on the voice output devices 32.

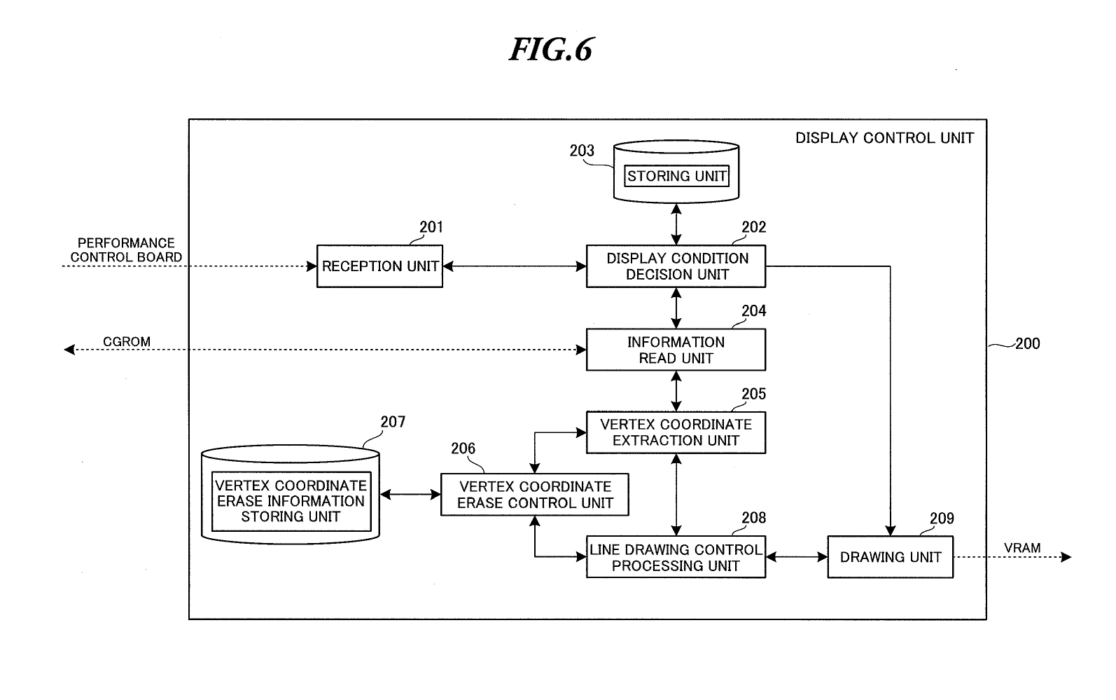

FIG. 6 is a diagram showing the detailed configuration of the display control unit which is configured through the application of the game machine, the display control method, and the display control program according to the present invention.

In FIG. 6, the display control unit 200 includes a reception unit 201, a display condition decision unit 202, a storing unit 203, an information read unit 204, a vertex coordinate extraction unit 205, a vertex coordinate erase control unit 206, a vertex coordinate erase information storing unit 27, a line drawing control processing unit 208, and a drawing unit 209.

When the reception unit 201 receives a display request for a performance image based on a performance pattern specification command from the performance control board 120, the reception unit 201 transmits the display request to the display condition decision unit 202. Here, the display condition decision unit 202 acquires “display condition information” stored in the storing unit 203.

Note that while the storing unit 203 and the vertex coordinate erase information storing unit 207 are included in the display control unit 200, they are not limited to such a configuration and may be arranged outside the image control unit (VDP) 2000.

The “display condition information” is condition information that specifies the display request for the display control unit 200 to perform display control processing of. For example, the “display condition information” includes a display request in a pseudo wire frame performance state on the basis of a performance pattern specification command.

If the display request transmitted from the reception unit 201 is decided to be one in a pseudo wire frame performance state specified by the “display condition information,” the display condition decision unit 202 issues a display request for a performance image based on the display request to the information read unit 204.

On the other hand, if the display request transmitted from the reception unit 201 is not contained in the one set by the “display condition information,” the display condition decision unit 202 instructs the drawing unit 209 to draw a performance image based on the display request transmitted from the reception unit 201.

When the drawing unit 209 is instructed by the display condition decision unit 202 to draw a performance image, the drawing unit 209 acquires image data to be used for drawing the instructed performance image, such as performance symbols and background images (movie), from the CG ROM 151 and draws the performance image based on the display request. The drawing unit 209 stores the drawn performance image into a buffer of the VRAM.

When a display request is given from the display condition decision unit 202, the information read unit 204 reads a three-dimensional object composed of polygons (also referred to as “polygon object”) from the CG ROM 151 as image data to be used for drawing the performance image based on the display request.

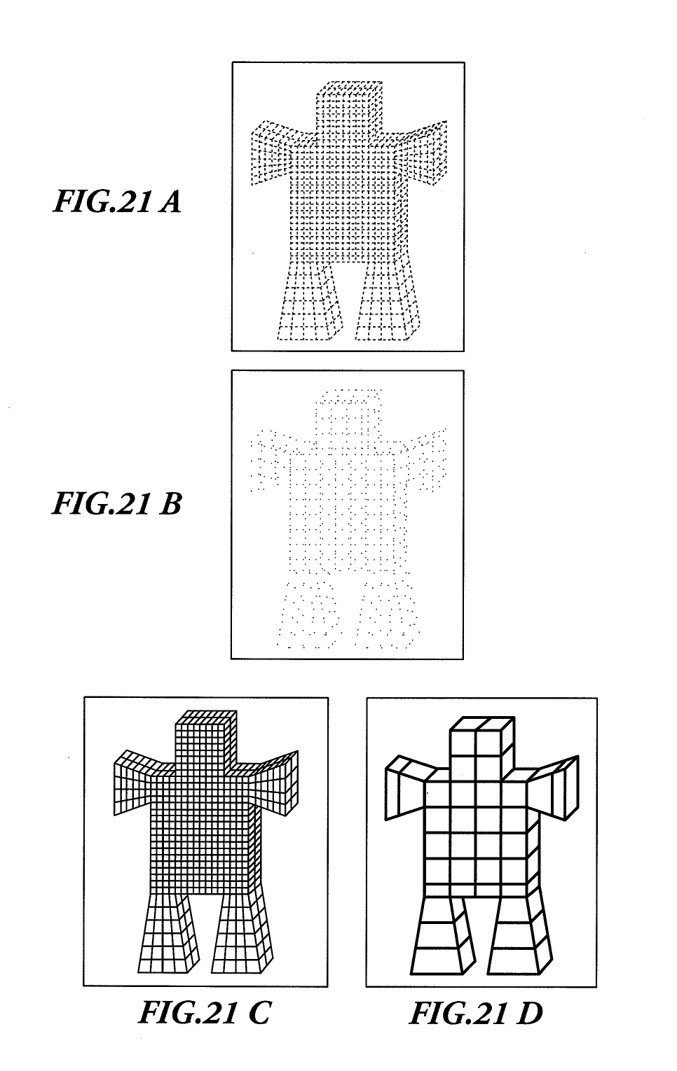

Examples of the three-dimensional object read from the CG ROM 151 include one shown in FIG. 21A. In FIG. 21A, each polygon is shown by dotted lines.

Subsequently, the information read unit 204 transmits the three-dimensional object read from the CG ROM 151 to the vertex coordinate extraction unit 205. Receiving the three-dimensional object from the information read unit 204, the vertex coordinate extraction unit 205 extracts the vertex coordinates of the polygons that constitute (form) the three-dimensional object.

FIG. 21B shows an example of the three-dimensional object whose vertex coordinates are extracted. In FIG. 21B, the extracted vertex coordinates of the polygons that constitute the three-dimensional object shown in FIG. 21A are represented by “dots.”

The polygons that constitute a three-dimensional object are information on the “surfaces” of the object with which the solid shape of the three-dimensional object is formed (also referred to as “surface forming information”), and are made of polygonal shapes such as triangles and rectangles. The polygons are therefore sometimes referred to as “polygonal data.”

The vertex coordinates extracted by the vertex coordinate extraction unit 205 are expressed in terms of spatial coordinates in a three-dimensional space.

The vertex coordinate extraction unit 205 then stores the information on the extracted vertex coordinates into a temporary storing area. If “erase presence/absence information” on vertex coordinates, which is intended for the thinning of vertex coordinates and set by the vertex coordinate extraction unit 205 in advance, includes “erase needed,” then the vertex coordinate extraction unit 205 instructs the vertex coordinate erase control unit 206 to erase vertex coordinates on the basis of the information on the vertex coordinates stored in the temporary storing area.

On the other hand, if the “erase presence/absence information” does not include “erase needed” or includes “erase not needed,” the vertex coordinate extraction unit 205 instructs the line drawing control processing unit 208 to perform line drawing processing to draw lines that connect the extracted vertex coordinates on the basis of the information on the vertex coordinates stored in the temporary storing area.

When instructed by the vertex coordinate extraction unit 205 to erase vertex coordinates, the vertex coordinate erase control unit 206 performs processing to read “vertex coordinate erase information” stored in the vertex coordinate erase information storing unit 207 and erase vertex coordinates on the basis of the vertex coordinate erase information. The vertex coordinate erase information is information that specifies the vertex coordinates to be erased in association with the performance state.

Reading the “vertex coordinate erase information,” the vertex coordinate erase control unit 206 erases the vertex coordinates specified by the vertex coordinate erase information in the performance state corresponding to the display request received by the reception unit 201, by using the information on the vertex coordinates stored in the temporary storing area.

After the erasure of the vertex coordinates, the vertex coordinate erase control unit 206 stores into the temporary storing area the information on the vertex coordinates from which some vertex coordinates are erased. The vertex coordinate erase control unit 206 then instructs the line drawing control processing unit 208 to perform line drawing processing between the vertex coordinates.

When the line drawing control processing unit 208 is instructed by the vertex coordinate extraction unit 205 or the vertex coordinate erase control unit 206 to perform line drawing processing, the line drawing control processing unit 208 performs the line drawing processing to draw lines that connect the vertex coordinates by using the information on the vertex coordinates stored in the temporary storing area. Consequently, a line-drawn three-dimensional object such as shown in FIGS. 21C and 21D is created.

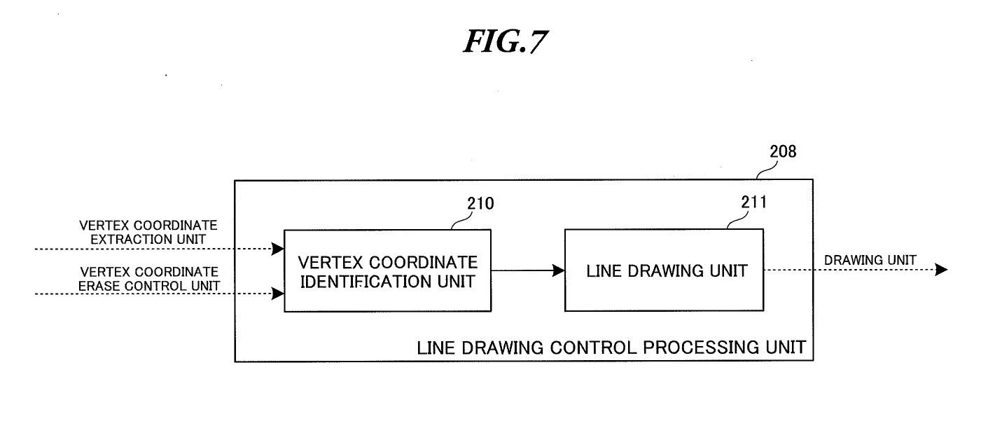

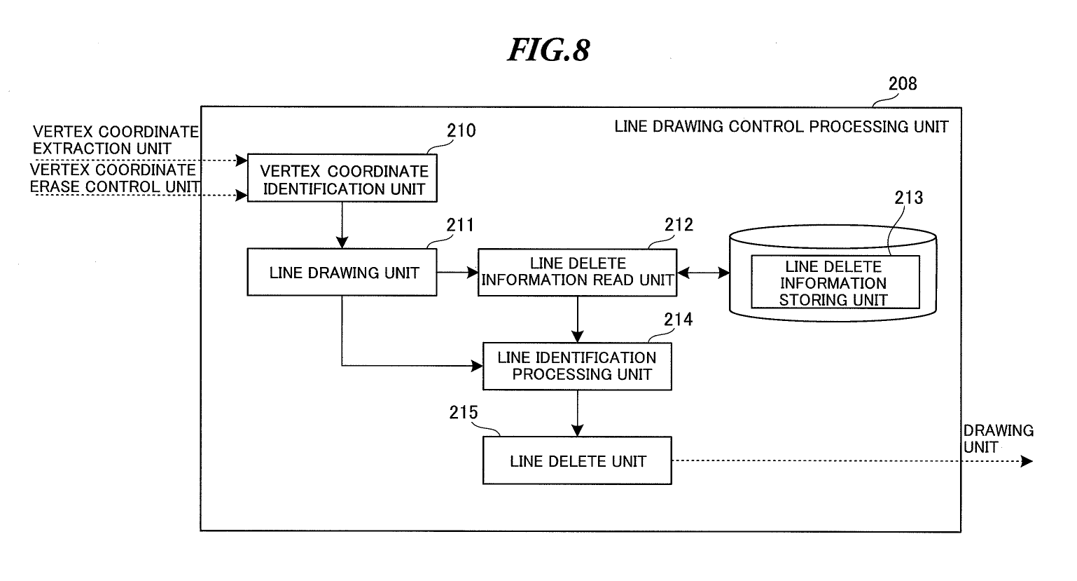

The detailed configuration of the line drawing control processing unit 208 is shown in FIGS. 7 and 8, which will be described later.

After the line drawing processing of the line drawing control processing unit 208, the three-dimensional object composed of a pseudo wire frame, which connects the vertex coordinates by lines, is transmitted to the drawing unit 209.

The drawing unit 209 performs rendering processing (drawing processing) on the received three-dimensional object composed of the pseudo wire frame, and stores the resultant into the VRAM.

FIG. 7 is a block diagram showing the detailed configuration of the line drawing control unit 208 shown in FIG. 6.

In FIG. 7, the line drawing control processing unit 280 includes a vertex coordinate identification unit 210 and a line drawing unit 211.

If there are vertex coordinates extracted by the vertex coordinate extraction unit 205 shown in FIG. 6 and the vertex coordinate extraction unit 205 decides that the “erase presence/absence information” includes “erase needed,” the information on the vertex coordinates is stored in the temporary storing area when the instruction for the line drawing control processing is given. The vertex coordinate identification unit 210 then identifies other vertex coordinates adjoining arbitrary vertex coordinates.

After the identification of other vertex coordinates adjoining arbitrary vertex coordinates, the vertex coordinate identification unit 210 instructs the line drawing unit 211 to connect the arbitrary vertex coordinates and the other adjoining vertex coordinates by lines. The line drawing unit 211 performs line drawing processing to draw lines between the arbitrary vertex coordinates and the other vertex coordinates.

Note that the other vertex coordinates adjoining arbitrary vertex coordinates are intended to identify adjoining vertexes among ones other than having already been specified as arbitrary vertex coordinates. The arbitrary vertex coordinates of which adjoining other vertex coordinates have been identified are therefore excluded from the candidates for, the adjoining vertexes.

Consequently, adjoining vertex coordinates for all the vertex coordinates are identified, and the line drawing processing is performed to draw lines between the vertex coordinates.

Now, if the instruction for the line drawing control processing is given by the vertex coordinate erase control unit 206, i.e., if there are vertex coordinate extracted by the vertex coordinate extraction unit 205 and the vertex coordinate extraction unit 205 decides that the “erase presence/absence information” does not include “erase needed” or includes “erase not needed,” some of the vertex coordinates of the three-dimensional object have been erased. Then, as in the foregoing, the vertex coordinate identification unit 210 identifies other vertex coordinates adjoining arbitrary vertex coordinates, and the line drawing unit 211 performs processing to connect the arbitrary vertex coordinates and the adjoining other vertex coordinates by lines.

FIG. 8 is a block diagram showing the detailed configuration of the line drawing control unit shown in FIG. 6.

In FIG. 8, the line drawing control processing unit 208 includes a vertex coordinate identification unit 210, a line drawing unit 211, a line delete information read unit 212, a line delete information storing unit 213, a line identification processing unit 214, and a line delete unit 215. Such a configuration is another example of the line drawing control processing unit of FIG. 7.

While the line delete information storing unit 213 is included in the line drawing control processing unit 208, it is not limited to such a configuration and may be arranged outside the image control unit (VDP) 2000.

If there are vertex coordinates extracted by the vertex coordinate extraction unit 205 shown in FIG. 6 and the vertex coordinate extraction unit 205 decides that the “erase presence/absence information” includes “erase needed,” the information on the vertex coordinates is stored in the temporary storing area when the instruction for the line drawing control processing is given. The vertex coordinate identification unit 210 then identifies other vertex coordinates adjoining arbitrary vertex coordinates.

After the identification of other vertex coordinates adjoining arbitrary vertex coordinates, the vertex coordinate identification unit 210 instructs the line drawing unit 211 to connect the arbitrary vertex coordinates and the other adjoining vertex coordinates by lines. The line drawing unit 211 performs the line drawing processing to draw lines between the arbitrary vertex coordinates and the other vertex coordinates.

Note that the other vertex coordinates adjoining arbitrary vertex coordinates are intended to identify adjoining vertexes among ones other than having already been specified as arbitrary vertex coordinates. The arbitrary vertex coordinates of which adjoining other vertex coordinates have been identified are therefore excluded from the candidates for the adjoining vertexes.

Consequently, adjoining vertex coordinates for all the vertex coordinates are identified, and the line drawing processing is performed to draw lines between the vertex coordinates. This generates a three-dimensional object in which lines are drawn between the vertex coordinates.

Now, if the instruction for the line drawing control processing is given by the vertex coordinate erase control unit 206, i.e., if there are vertex coordinate extracted by the vertex coordinate extraction unit 205 and the vertex coordinate extraction unit 205 decides that the “erase presence/absence information” does not include “erase needed” or includes “erase not needed,” some of the vertex coordinates of the three-dimensional object have been erased. Then, as in the foregoing, the vertex coordinate identification unit 210 identifies other vertex coordinates adjoining arbitrary vertex coordinates, and the line drawing unit 211 performs processing to connect the arbitrary vertex coordinates and the adjoining other vertex coordinates by lines. This generates a three-dimensional object in which lines are drawn between the vertex coordinates.

After the generation of the three-dimensional object with the line-drawn vertex coordinates, the line drawing unit 211 transmits the three-dimensional object to the line identification processing unit 214 and instructs the line delete information read unit 212 to read line delete information. The line delete information read unit 212 reads “line delete information” stored in the line delete information storing unit 213.

The line delete information includes (1) information for identifying lines to delete and (2) information on the line delete rate, and the like.

Reading the line delete information, the line delete information read unit 212 transmits the line delete information to the line identification processing unit 214.

Using the three-dimensional object received from the line drawing unit 211, the line identification processing unit 214 performs processing to identify lines that are based on the line delete information. For example, if the line delete information includes “(1) information for identifying lines to delete,” the line identification processing unit 214 identifies the lines of the three-dimensional object that are identified by the information.

If the line delete information is “(2) the line delete rate,” the line identification processing unit 214 determines the number of lines to delete based on the “line delete rate” (the number of lines that constitute the three-dimensional object×the delete rate). The line identification processing unit 214 identifies the lines to delete by extracting as many lines as the determined number of lines to delete at random from those constituting the three-dimensional object.

After the identification of the lines, the line identification processing unit 214 transmits the three-dimensional object and the information on the identified lines to the line delete unit 215.

The line delete unit 215 then performs processing to delete lines constituting the three-dimensional object on the basis of the information on the lines. The line delete unit 215 transmits the line-deleted three-dimensional object based on the information on the lines to the drawing unit 209 shown in FIG. 6.

Next, the progress of a game with the game machine 1 will be described with reference to flowcharts.

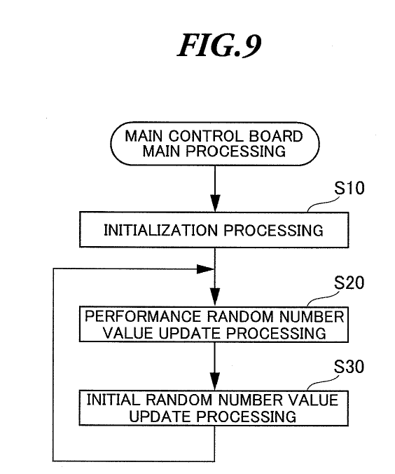

Referring to FIG. 9, the main processing of the main control board 110 will be described.

When power is supplied from the power supply board 170, a system reset occurs in the main CPU 110a. The main CPU 110a performs the following main processing.

Initially, at step S10, the main CPU 110a performs initialization processing. In the processing, the main CPU 110a reads a startup program from the main ROM 110b in response to the power-on, and performs processing to initialize flags and the like stored in the main RAM 110c.

At step S20, the main CPU 110a performs performance random number value update processing to update a reach judgment random number value and a special symbol variation random number value which are intended to determine the variation mode (variation time) of special symbols.

At step S30, the main CPU 110a updates a special symbol judgment initial random number value, a jackpot symbol initial random number value, a small jackpot symbol initial random number value, and a normal symbol judgment initial random number value. Subsequently, the main CPU 110a repeats the processing of steps S20 and S30 until predetermined interrupt processing is performed.

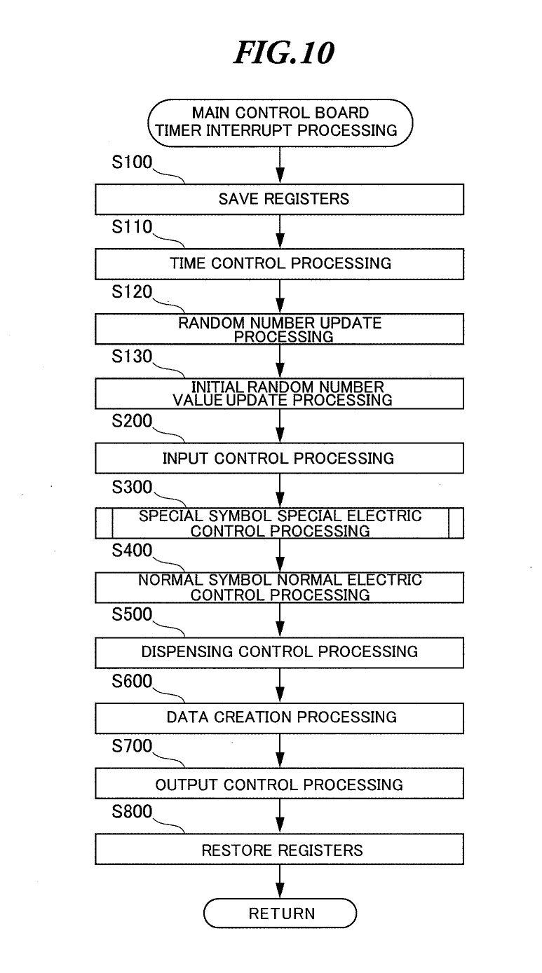

Referring to FIG. 10, timer interrupt processing of the main control board 110 will be described.

A resetting clock pulse generation circuit provided on the main control board 110 generates a clock pulse at predetermined intervals (4 ms), which initiates the following timer interrupt processing.

Initially, at step S100, the main CPU 110a saves the information stored in the registers of the main CPU 110a to a stack area.

At step S110, the main CPU 110a performs time control processing to update various types of timer counters. The time control processing includes the processing of updating the special symbol time counter, the processing of updating the special game timer counter which pertains to the open time of special electrical gadgets and the like, the processing of updating a normal symbol time counter, and the processing of updating a normal electric open time counter. Specifically, the main CPU 110a performs processing to subtract 1 from the special symbol time counter, the special game timer counter, the normal symbol time counter, and the normal electric open time counter.

At step S120, the main CPU 110a performs random number update processing on the special symbol judgment random number value, the jackpot symbol random number value, the small jackpot symbol random number value, and the normal symbol judgment random number value.

Specifically, the main CPU 110a adds 1 to the random number values and random number counters for update. If an added random number counter exceeds the maximum value of its random number range (when the random number counter goes around), the main CPU 110a resets the random number counter to 0 and updates the random number values anew from the respective initial random number values at that time.

At step S130, the main CPU 110a performs initial random number value update processing to update the special symbol judgment initial random number value, the jackpot symbol initial random number value, the small jackpot symbol initial random number value, and the normal symbol judgment initial random number value as in step S30.

At step S200, the main CPU 110a performs input control processing.

In the processing, the main CPU 110a performs input processing to determine whether there is an input to each of the general prize hole detection switch 12a, the first bonus prize hole detection switch 16a, the second bonus prize hole detection switch 17a, the first start hole detection switch 14a, the second start hole detection switch 15a, and the gate detection switch 13a.

Specifically, when various detection signals are input from the general prize hole detection switch 12a, the first bonus prize hole detection switch 16a, the second bonus prize hole detection switch 17a, the first start hole detection switch 14a, and the second start hole detection switch 15a, the main CPU 110a adds predetermined data to respective winning ball counters for update. The winning ball counters are arranged for the respective prize holes and used for winning balls.

If the detection signal from the first start hole detection switch 14a is input and the data set in the first special symbol reserved number (U1) storing area is smaller than 4, the main CPU 110a adds 1 to the first special symbol reserved number (U1) storing area. The main CPU 110a then acquires the special symbol judgment random number value, the jackpot symbol random number value, the small jackpot symbol random number value, the reach judgment random number value, and the special symbol variation random number value, and stores the acquired various random number values into a predetermined storing section (zeroth storing section to fourth storing section) in the first special symbol random number value storing area.

Similarly, if the detection signal from the second start hole detection switch 15a is input and the data set in the second special symbol reserved number (U2) storing area is smaller than 4, the main CPU 110a adds 1 to the second special symbol reserved number (U2) storing area. The main CPU 110a then acquires the special symbol judgment random number value, the jackpot symbol random number value, the small jackpot symbol random number value, the reach judgment random number value, and the special symbol variation random number value, and stores the acquired various random number values into a predetermined storing section (zeroth storing section to fourth storing section) in the second special symbol random number value storing area.

If the detection signal from the gate detection switch 13a is input and the data set in the normal symbol reserved number (G) storing area is smaller than 4, the main CPU 110a adds 1 to the normal symbol reserved number (G) storing area. The main CPU 110a then acquires the normal symbol judgment random number value, and stores the acquired normal symbol judgment random number value into a predetermined storing section (zeroth storing section to fourth storing section) in the normal symbol reservation storing area.

If the detection signal from the first bonus prize hole detection switch 16a or the second bonus prize hole detection switch 17a is input, the main CPU 110a adds 1 to the bonus prize hole entering ball number (C) storing area for update. The bonus prize hole entering ball number (C) storing area is intended to count game balls entering the first bonus prize hole 16 or the second bonus prize hole 17.

At step S300, the main CPU 110a performs special symbol special electric control processing for performing jackpot drawing and controlling the special electrical gadget and the game state.

At step S400, the main CPU 110a performs normal symbol normal electric control processing for performing normal symbol drawing and controlling the normal electrical gadgets.

Specifically, the main CPU 110a initially determines if data of 1 or higher is set in the normal symbol reserved number (G) storing area. The main CPU 110a ends the normal symbol normal electric control processing this time unless data of 1 or higher is set in the normal symbol reserved number (G) storing area.

If data of 1 or higher is set in the normal symbol reserved number (G) storing area, the main CPU 110a subtracts 1 from the value stored in the normal symbol reserved number (G) storing area. The main CPU 110a then shifts the normal symbol judgment random number values stored in the first to fourth storing sections of the normal symbol reservation storing area to the respective preceding storing sections. This overwrites and erases the normal symbol judgment random number value that is previously written in the zeroth storing section.

The main CPU 110a then performs processing to judge whether the normal symbol judgment random number value stored in the zeroth storing section of the normal symbol reservation storing area corresponds to a “win.” Subsequently, the normal symbol display device 22 displays normal symbols with variations and stops at a normal symbol that corresponds to the result of normal symbol drawing after a lapse of the normal symbol variation time. If the normal symbol judgment random number value referenced hits a “win,” the start hole opening and closing solenoid 15c is driven to control the second start hole 15 to the second mode for a predetermined open time.

When in a non-quick game state, the normal symbol variation time is set to 29 sec. If “win,” the second start hole 15 is controlled to the second mode for 0.2 sec. On the other hand, when in the quick game state, the normal symbol variation time is set to 0.2 sec. If “win,” the second start hole 15 is controlled to the second mode for 3.5 sec.

At step S500, the main CPU 110a performs dispensing control processing.

In the dispensing control processing, the main CPU 110a refers to the respective winning ball counters to generate dispensing number specification commands corresponding to the respective prize holes, and transmits the generated dispensing number specification commands to the dispensing control board 130.

At step S600, the main CPU 110a performs processing to create external information data, start hole opening and closing solenoid data, first bonus prize hole opening and closing solenoid data, second bonus prize hole opening and closing solenoid data, special symbol display device data, normal symbol display device data, and data on a stored number specification command.

At step S700, the main CPU 110a performs output control processing. In the processing, the main CPU 110a performs port output processing to output the signals of the external information data, the start hole opening and closing solenoid data, the first bonus prize hole opening and closing solenoid data, and the second bonus prize hole opening and closing solenoid data which are created in the foregoing step S600.

In order to light the LEDs of the first special symbol display device 20, the second special symbol display device 21, and the normal symbol display device 22, the main CPU 110a performs display device output processing to output the special symbol display device data and the normal symbol display device data which are created in the foregoing step S600.

The main CPU 110a also performs command transmission processing to transmit commands set in the performance transmission data storage area of the main RAM 110c to the performance control board 120.

At step S800, the main CPU 110a restores the information saved in step S100 to the registers of the main CPU 110a.

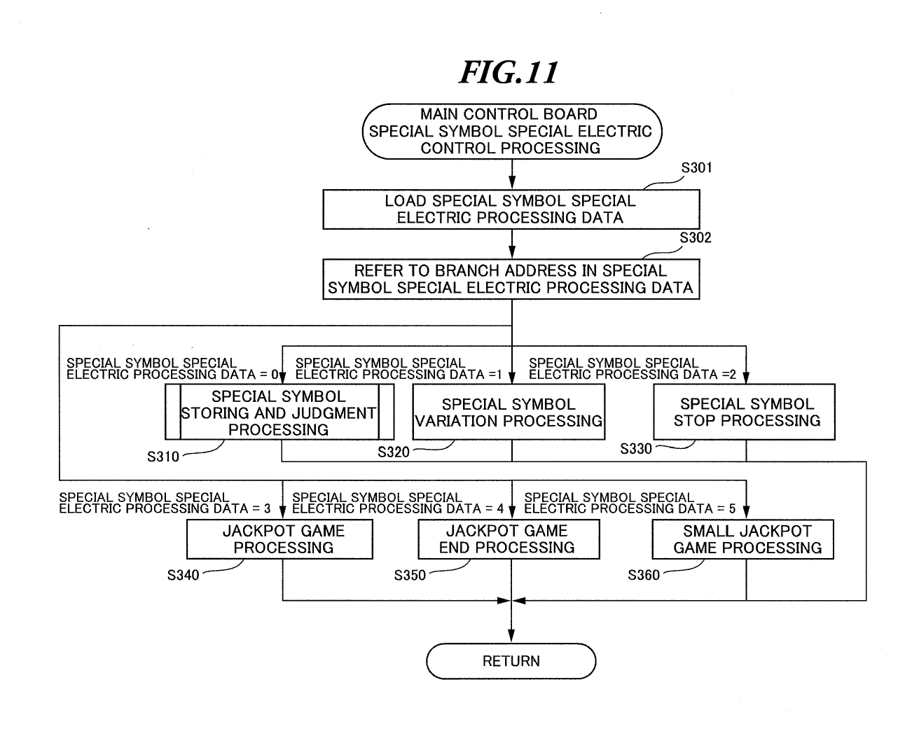

Referring to FIG. 11, the special symbol special electric control processing of the main control board 110 will be described.

Initially, at step S301, the main CPU 110a loads the value of special symbol special electric processing data. At step S302, the main CPU 110a refers to a branch address included in the special symbol special electric processing data loaded. If the special symbol special electric processing data=0, the main CPU 110a shifts the processing to special symbol storing and judgment processing (step S310). If the special symbol special electric processing data=1, the main CPU 110a shifts the processing to special symbol variation processing (step S320). If the special symbol special electric processing data=2, the main CPU 110a shifts the processing to special symbol stop processing (step S330). If the special symbol special electric processing data=3, the main CPU 110a shifts the processing to jackpot game processing (step S340). If the special symbol special electric processing data=4, the main CPU 110a shifts the processing to jackpot game end processing (step S350). If the special symbol special electric processing data=5, the main CPU 110a shifts the processing to small jackpot game processing (step S360).

The “special symbol special electric processing data” is set in each subroutine of the special symbol special electric control processing when necessary, as described later, so that subroutines necessary for a game are processed as appropriate.

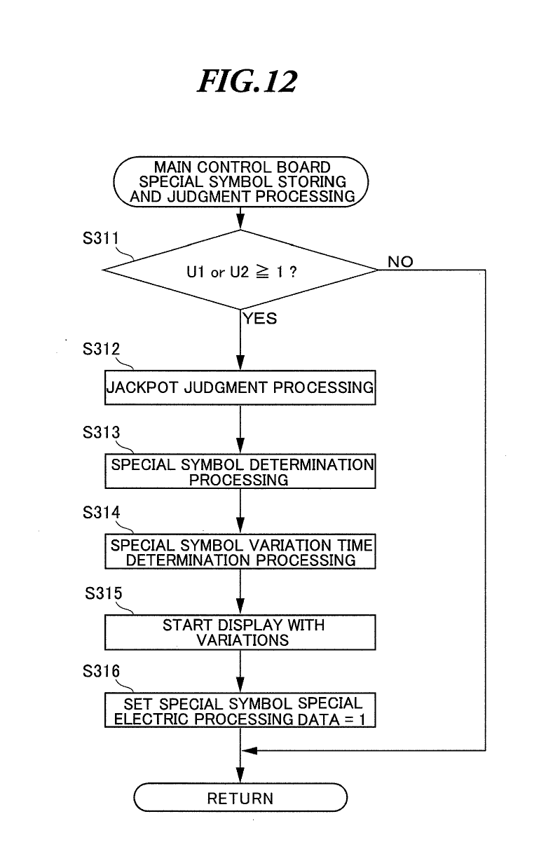

In the special symbol storing and judgment processing of step S310, the main CPU 110a performs such processing as jackpot judgment processing, special symbol determination processing for determining a special symbol to stop and display, and variation time determination processing for determining the special symbol variation time. Referring to FIG. 12, the special symbol storing and judgment processing will now be described in the concrete.

FIG. 12 is a flowchart showing the special symbol storing and judgment processing of the main control board 110.

Initially, at step S311, the main CPU 110a judges whether data of 1 or higher is set in the first special symbol reserved number (U1) storing area or the second special symbol reserved number (U2) storing area.

If data of 1 or higher is set in neither of the first special symbol reserved number (U1) storing area or the second special symbol reserved number (U2) storing area, the main CPU 110a ends the special symbol storing and judgment processing this time while maintaining the special symbol special electric processing data=0.

On the other hand, if data of 1 or higher is set in the first special symbol reserved number (U1) storing area or the second special symbol reserved number (U2) storing area, the main CPU 110a shifts the processing to step S312.

At step S312, the main CPU 110a performs the jackpot judgment processing.

Specifically, if data of 1 or higher is set in the second special symbol reserved number (U2) storing area, the main CPU 110a subtracts 1 from the value stored in the second special symbol reserved number (U2) storing area. The main CPU 110a then shifts the various random number values stored in the first to fourth storing sections of the second special symbol random number value storing area to the respective preceding storing sections. This overwrites and erases the various random number values that are previously written in the zeroth storing section. The main CPU 110a then judges whether the special symbol judgment random number value stored in the zeroth storing section of the second special symbol random number value storing area corresponds to a “jackpot,” or whether the random number value corresponds to a “small jackpot.”

If data of 1 or higher is not set in the second special symbol reserved number (U2) storing area and data of 1 or higher is set in the first special symbol reserved number (U1) storing area, the main CPU 110a subtracts 1 from the value stored in the first special symbol reserved number (U1) storing area. The main CPU 110a then shifts the various random number values stored in the first to fourth storing sections of the first special symbol random number value storing area to the respective preceding storing sections. Again, this overwrites and erases the various random number values that are previously written in the zeroth storing section. The main CPU 110a then judges whether the special symbol judgment random number value stored in the zeroth storing section of the first special symbol random number value storing area corresponds to a “jackpot,” or whether the random number value corresponds to a “small jackpot.”

In the present embodiment, the random number values stored in the second special symbol random number value storing area are shifted (consumed) with priority over those stored in the first special symbol random number value storing area.

However, the first special symbol random number value storing area and the second special symbol random number value storing area may be, shifted in order of entry into the start holes. The first special symbol random number value storing area may be shifted with priority over the second special symbol random number value storing area.

At step S313, the main CPU 110a performs the special symbol determination processing for determining the type of the special symbol to stop and display.

In the special symbol determination processing, the main CPU 110a determines a jackpot symbol on the basis of the jackpot symbol random number value stored in the zeroth storing section of the first special symbol random number value storing area if the foregoing jackpot judgment processing (step S312) results in a “jackpot.” If the foregoing jackpot judgment processing (step S312) results in a “small jackpot,” the main CPU 110a determines a small jackpot symbol on the basis of the small jackpot symbol random number value stored in the zeroth storing section of the first special symbol random number value storing area. If the foregoing jackpot judgment processing (step S312) results in a “miss,” the main CPU 110a determines a miss symbol.

The main CPU 110a then stores stop symbol data corresponding to the determined special symbol into the stop symbol data storing area.

At step S314, the main CPU 110a performs the variation time determination processing for the special symbol.

Specifically, the main CPU 110a determines the variation pattern of special symbols on the basis of the reach judgment random number value and the special symbol variation random number value stored in the zeroth storing section of the first special symbol random number value storing area. Subsequently, the main CPU 110a determines the special symbol variation time corresponding to the variation pattern of special symbols determined. The main CPU 110a then performs processing to set the special symbol time counter to a counter value corresponding to the special symbol variation time determined.

At step S315, the main CPU 110a sets variation display data for making the first special symbol display device 20 or the second special symbol display device 21 display special symbols with variations (LED blinking), into a predetermined processing area. With the variation display data set in the predetermined processing area, data for turning on/off the LEDs is appropriately created in the foregoing step S600. The created data is output at step S700, whereby the first special symbol display device 20 or the second special symbol display device 21 makes a display with variations.

When starting to display special symbols with variations, the main CPU 110a sets a special symbol variable pattern specification command (first special symbol variation pattern specification command or second special symbol variation pattern specification command) that corresponds to the variation pattern of special symbols determined in the foregoing step S314, into the performance transmission data storage area of the main RAM 110c.

At step S316, the main CPU 110a changes “the special symbol special electric processing data=0” to “the special symbol special electric processing data=1,” thereby preparing for a shift into the subroutine for the special symbol variation processing. The main CPU 110a then ends the special symbol storing and judgment processing.

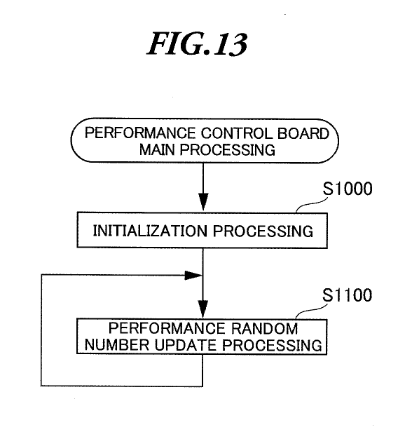

Referring to FIG. 13, the main processing of the performance control board 120 will be described.

At step S1000, the sub CPU 120a performs initialization processing. In the processing, the sub CPU 120a reads a main processing program from the sub ROM 120b in response to the power-on, and performs processing to initialize and set flags and the like stored in the sub RAM 120c. After the end of the processing, the sub CPU 120a shifts the processing to step S1400.

At step S1100, the sub CPU 120a performs performance random number update processing. In the processing, the sub CPU 120a performs processing to update random numbers (such as performance random number value 1, performance random number value 2, performance symbol determination random number value, and performance mode determination random number value) stored in the sub RAM 120c. Subsequently, the sub CPU 120a repeats the processing of the step S1100 described above until predetermined interrupt processing is performed.

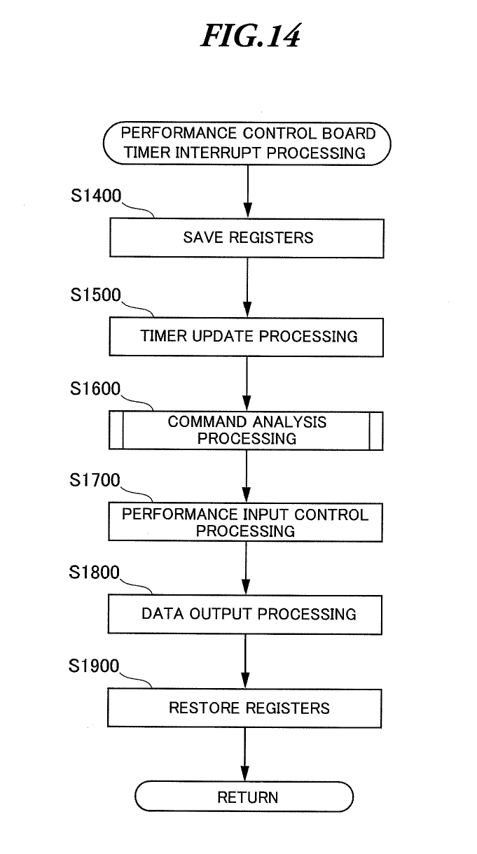

Referring to FIG. 14, timer interrupt processing of the performance control board 120 will be described.

A not-shown resetting clock pulse generation circuit provided on the performance control board 120 generates a clock pulse at predetermined intervals (2 ms). A timer interrupt processing program is read, and the timer interrupt processing of the performance control board is performed.

Initially, at step S1400, the sub CPU 120a saves the information stored in the registers of the sub CPU 120a to a stack area.

At step S1500, the sub CPU 120a performs processing to update various timer counters that are used in the performance control board 120.

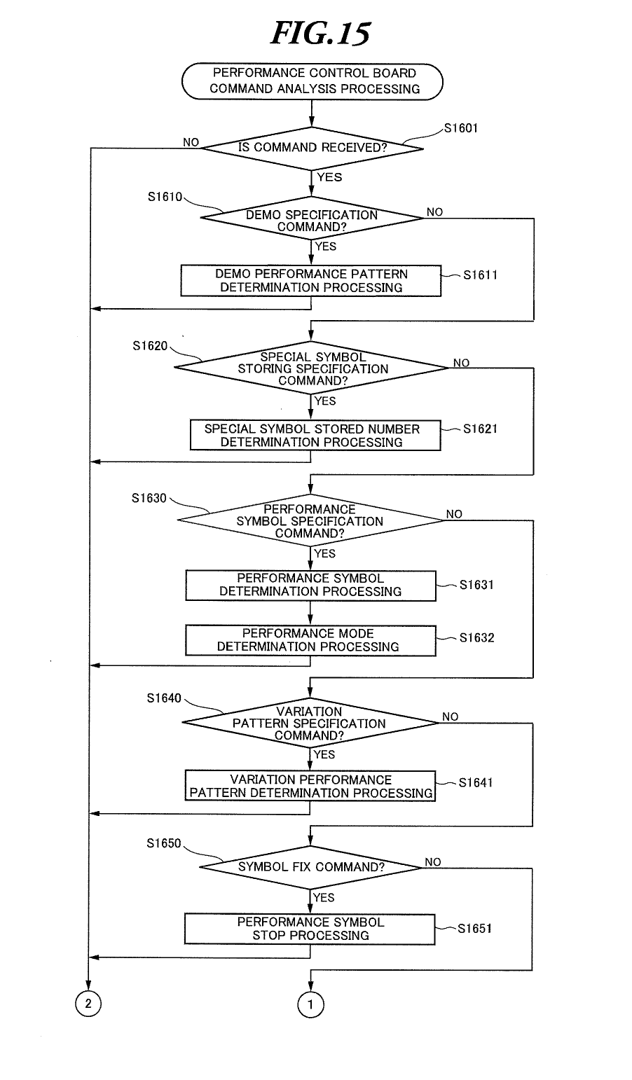

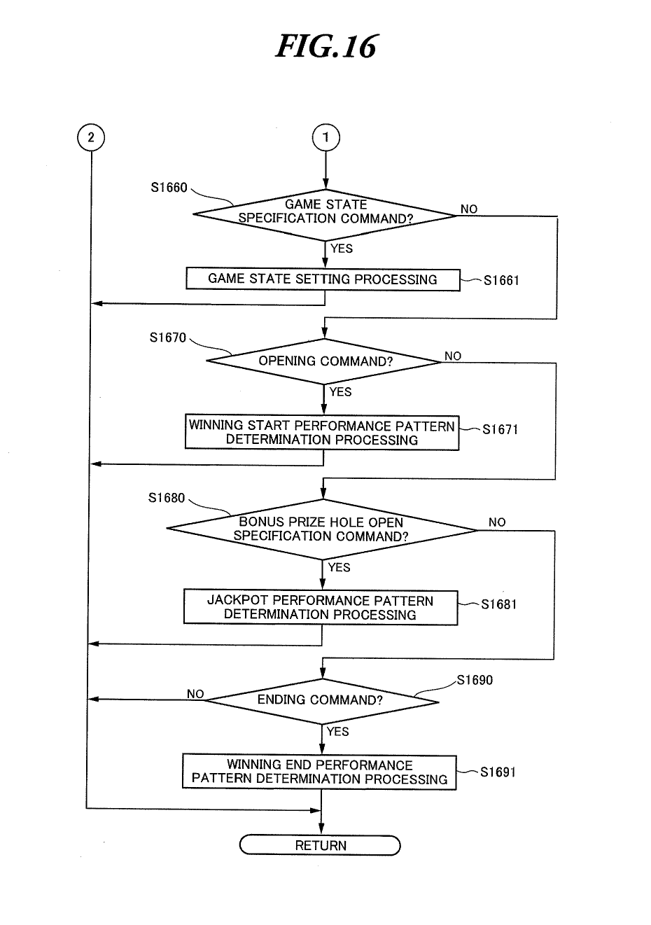

At step S1600, the sub CPU 120a performs command analysis processing. In the processing, the sub CPU 120a performs processing to analyze a command that is stored in a reception buffer of the sub RAM 120c. The command analysis processing will be detailed later with reference to FIGS. 15 and 16. When the performance control board 120 receives a command transmitted from the main control board 110, not-shown command reception interrupt processing occurs in the performance control board 120, whereby the received command is stored into the reception buffer. Subsequently, the processing of analyzing the received command is performed in this step S1600.

At step S1700, the sub CPU 120a checks for the signal of the performance button detection switch 35a, and performs performance input control processing on the performance button 35.

At step S1800, the sub CPU 120a performs data output processing to transmit various types of commands set in a transmission buffer of the sub RAM 120c to the lamp control board 140 and the image control board 150.

At step S1900, the sub CPU 120a restores the information saved in step S1400 to the registers of the sub CPU 120a.

Referring to FIGS. 15 and 16, the command analysis processing of the performance control board 120 will be described. It should be appreciated that the command analysis processing 2 of FIG. 16 is performed in succession to the command analysis processing 1 of FIG. 15.

At step S1601, the sub CPU 120a checks for the presence or absence of a command in the reception buffer, thereby checking for command reception.

If there is no command in the reception buffer, the sub CPU 120a ends the command analysis processing. If there is a command in the reception buffer, the sub CPU 120a shifts the processing to step S1610.

At step S1610, the sub CPU 120a checks whether the command stored in the reception buffer is a demo specification command.

If the command stored in the reception buffer is a demo specification command, the sub CPU 120a shifts the processing to step S1611. If not a demo specification command, the sub CPU 120a shifts the processing to step S1620.

At step S1611, the sub CPU 120a performs demo performance pattern determination processing to determine a demo performance pattern.

Specifically, the sub CPU 120a determines the demo performance pattern, and sets the determined demo performance pattern into the performance pattern storing area. To transmit the information on the determined demo performance pattern to the image control board 150 and the lamp control board 140, the sub CPU 120a further sets a performance pattern specification command based on the determined demo performance pattern into the transmission buffer of the sub RAM 120c.

At step S1620, the sub CPU 120a checks whether the command stored in the reception buffer is a special symbol storing specification command.

If the command stored in the reception buffer is a special symbol storing specification command, the sub CPU 120a shifts the processing to step S1621. If not a special symbol storing specification command, the sub CPU 120a shifts the processing to step S1630.

At step S1621, the sub CPU 120a performs special symbol stored number determination processing. In the processing, the sub CPU 120a analyzes the special symbol storing specification command to determine the number of special symbol reservation images for the liquid crystal display 31 to display, and transmits a special symbol display number specification command corresponding to the determined number of special symbol reservation images to display to the image control board 150 and the lamp control board 140.

At step S1630, the sub CPU 120a checks whether the command stored in the reception buffer is a performance symbol specification command.

If the command stored in the reception buffer is a performance symbol specification command, the sub CPU 120a shifts the processing to step S1631. If not a performance symbol specification command, the sub CPU 120a shifts the processing to step S1640.

At step S1631, the sub CPU 120a performs performance symbol determination processing to determine the performance symbol 36 to be stopped and displayed on the liquid crystal display 31 on the basis of the content of the performance symbol specification command received.

Specifically, the sub CPU 120a analyzes the performance symbol specification command to determine performance symbol data that constitutes a combination of performance symbols 36 depending on the presence or absence of a jackpot and the type of the jackpot. The sub CPU 120a sets the determined performance symbol data into the performance symbol storing area. To transmit the performance symbol data to the image control board 150 and the lamp control board 140, the sub CPU 120a also sets a stop symbol specification command that indicates the performance symbol data into the transmission buffer of the sub RAM 120c.

At step S1632, the sub CPU 120a performs performance mode determination processing. In the processing, the sub CPU 120a acquires a random number value from the performance mode determination random number values updated in the foregoing step S1100, and determines a performance mode from among a plurality of performance modes (such as normal performance mode and chance performance mode) on the basis of the performance mode determination random number value acquired and the performance symbol specification command received. The determined performance mode is set into the performance mode storing area.

At step S1640, the sub CPU 120a checks whether the command stored in the reception buffer is a variation pattern specification command.

If the command stored in the reception buffer is a variation pattern specification command, the sub CPU 120a shifts the processing to step S1641. If not a variation pattern specification command, the sub CPU 120a shifts the processing to step S1650.

At step S1641, the sub CPU 120a performs variation performance pattern determination processing. In the processing, the sub CPU 120a acquires a random number value from the performance random number values 1 updated in the foregoing step S1100, and determines a variation performance pattern from among a plurality of variation performance patterns on the basis of the performance random number value 1 acquired, the variation pattern specification command received, and the performance mode set in the performance mode storing area.

Subsequently, the liquid crystal display 31, the voice output devices 32, the performance drive device 33, and the performance illumination devices 34 are controlled on the basis of the performance pattern. It should be noted that the variation mode of the performance symbols 36 is determined on the basis of the variation performance pattern determined here.

At step S1650, the sub CPU 120a checks whether the command stored in the reception buffer is a symbol fix command.

If the command stored in the reception buffer is a symbol fix command, the sub CPU 120a shifts the processing to step S1651. If not a symbol fix command, the sub CPU 120a shifts the processing to step S1660.

At step S1651, the sub CPU 120a performs performance symbol stop display processing. In the processing, the sub CPU 120a sets a stop specification command for stopping and displaying a performance symbol into the transmission buffer of the sub RAM 120c in order to stop and display a performance symbol 36.

At step S1660, the sub CPU 120a judges whether the command stored in the reception buffer is a game state specification command.

If the command stored in the reception buffer is a game state specification command, the sub CPU 120a shifts the processing to step S1661. If not a game state specification command, the sub CPU 120a shifts the processing to step S1670.

At step S1661, the sub CPU 120a sets data that indicates the game state based on the received game state specification command, into the game state storing area of the sub RAM 120c.

At step S1670, the sub CPU 120a checks whether the command stored in the reception buffer is an opening command.

If the command stored in the reception buffer is an opening command, the sub CPU 120a shifts the processing to step S1671. If not an opening command, the sub CPU 120a shifts the processing to step S1680.

At step S1671, the sub CPU 120a performs winning start performance pattern determination processing to determine a winning start performance pattern.

Specifically, the sub CPU 120a determines the winning start performance pattern on the basis of the opening command, and sets the determined winning start performance pattern into the performance pattern storing area. To transmit the information on the determined winning start performance pattern to the image control board 150 and the lamp control board 140, the sub CPU 120a further sets a performance pattern specification command based on the determined winning start performance pattern into the transmission buffer of the sub RAM 120c.

At step S1680, the sub CPU 120a checks whether the command stored in the reception buffer is a bonus prize hole open specification command.

If the command stored in the reception buffer is a bonus prize hole open specification command, the sub CPU 120a shifts the processing to step S1681. If not a bonus prize hole open specification command, the sub CPU 120a shifts the processing to step S1690.

At step S1681, the sub CPU 120a performs jackpot performance pattern determination processing to determine a jackpot performance pattern.

Specifically, the sub CPU 120a determines the jackpot performance pattern on the basis of the bonus prize hole open specification command, and sets the determined jackpot performance pattern into the performance pattern storing area. To transmit the information on the determined jackpot performance pattern to the image control board 150 and the lamp control board 140, the sub CPU 120a further sets a performance pattern specification command based on the determined jackpot performance pattern into the transmission buffer of the sub RAM 120c.

At step S1690, the sub CPU 120a checks whether the command stored in the reception buffer is an ending command.

If the command stored in the reception buffer is an ending command, the sub CPU 120a shifts the processing to step S1691. If not an ending command, the sub CPU 120a ends the command analysis processing.

At step S1691, the sub CPU 120a performs winning end performance pattern determination processing to determine a winning end performance pattern.

Specifically, the sub CPU 120a determines the winning end performance pattern on the basis of the ending command, and sets the determined winning end performance pattern into the performance pattern storing area. To transmit the information on the determined winning end performance pattern to the image control board 150 and the lamp control board 140, the sub CPU 120a further sets a performance pattern specification command based on the determined winning end performance pattern into the transmission buffer of the sub RAM 120c. After the completion of the processing, the command analysis processing ends.

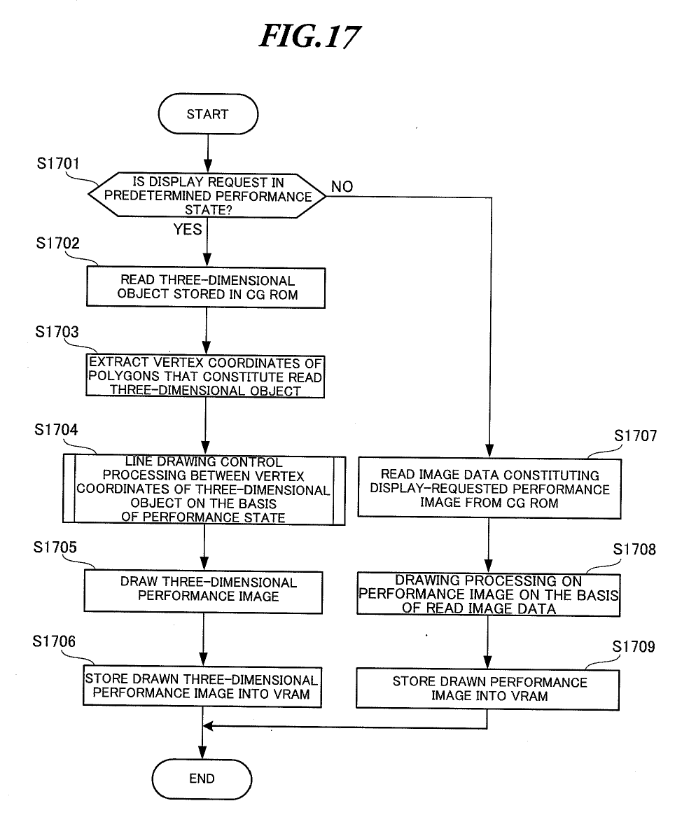

FIG. 17 is a flowchart showing the detailed procedure of display control processing to be performed by the display control unit which is configured through the application of the game machine, the display control method, and the display control program according to the embodiment of the present invention.

In FIG. 17, the display control unit 200 which constitutes the performance control unit (VDP) of the game machine starts processing when it receives a display request from the performance control board 120 with a polygon-based three-dimensional object stored in the CG ROM 151. The display control unit 200 decides whether the display request received is a previously-specified one (S1701).

As mentioned previously, the display request here is specified by a performance pattern specification command. The display control unit 200 decides whether the performance pattern specification command is one for providing a predetermined performance (S1701). In this decision processing, the display control unit 200 decides whether the display request is in a performance state that is specified by the “display condition information” stored in advance.

If the display request is in the performance state specified by the “display condition information” (YES at S1701), for example, if a display request for pseudo wire frame performance is registered in the “display condition information” and the display request received is one for pseudo wire frame performance using a three-dimensional object, the display request is decided to be in the predetermined performance state. In such a case, the display control unit 200 reads object information on the “three-dimensional object” that constitutes the performance image to be displayed on the basis of the display request that is stored in the CG ROM 151 (S1702). The display control unit 200 stores the object information into a temporary storing area such as a cache.

As mentioned previously, the “three-dimensional object” is an object composed of polygons which are surface forming information for forming a solid body.

The display control unit 200 extracts the vertex coordinates that constitute the polygonal surfaces of the read “three-dimensional object” (for example, the coordinates of three vertexes if the surface is triangular; the coordinates of four vertexes if the surface is rectangular), i.e., spatial coordinates in a three-dimensional virtual space (S1703).

After the extraction of the vertex coordinates of the polygons constituting the three-dimensional object, the display control unit 200 performs the line drawing control processing to draw lines between the extracted vertex coordinates on the basis of a performance condition specified in advance (S1704).

The line drawing control processing is to draw straight lines between the extracted vertex coordinates, thereby generating a three-dimensional object composed of a pseudo wire frame which can visualize a three-dimensional model.

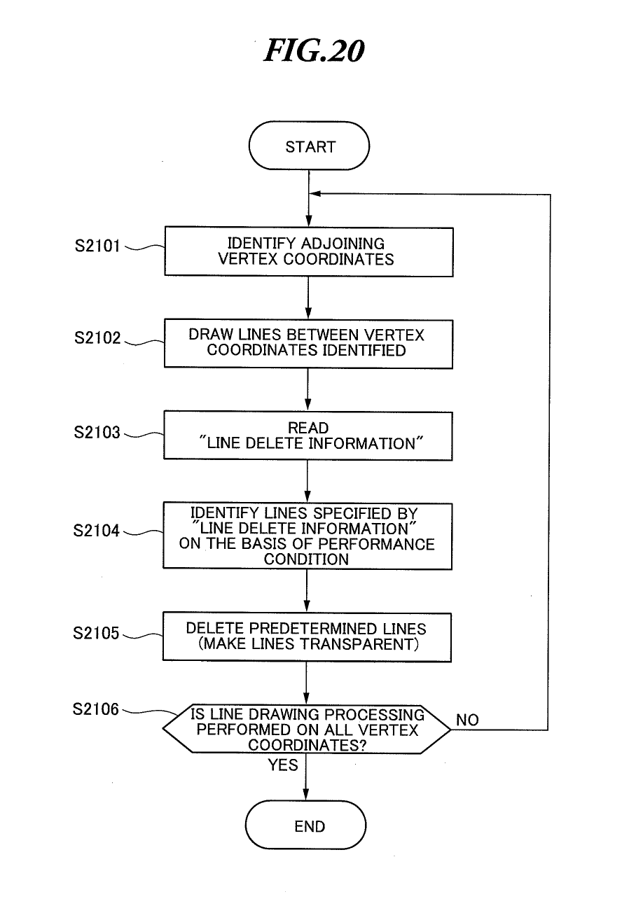

The detailed procedure of the line drawing control processing is shown in the flowcharts of FIGS. 19 and 20, which will be described later.

After the drawing of lines between the vertex coordinates of the three-dimensional object through such line drawing control processing, the display control unit 200 draws a three-dimensional performance image to be displayed on the liquid crystal display on the basis of the three-dimensional object (S1705). The display control unit 200 stores the drawn three-dimensional performance image into the VRAM (S1706).

When the three-dimensional performance image is thus stored in the VRAM, the image control unit (VDP) 2000 reads the three-dimensional performance image stored in the VRAM and displays the image on the liquid crystal display 31.

The foregoing description has dealt with the processing where the display request received is in the performance state that is specified by the “display condition information” based on the performance pattern specification command. If the display request received is not in the performance state specified by the “display condition information” based on the performance pattern specification command (NO at S1701), the display control unit 200 reads image data that constitutes the performance image based on the performance pattern specification command of that display request from the CG ROM 151 (S1707). The display control 200 draws the performance image to be displayed on the liquid crystal display on the basis of the read image data (S1708).

After the drawing of the performance image, the display control unit 200 stores the performance image into the VRAM (S1709).

Again, when the three-dimensional performance image is stored in the VRAM, the image control unit (VDP) 2000 reads the three-dimensional performance image stored in the VRAM and displays the image on the liquid crystal display 31.

FIG. 18 is another example of the flowchart showing the detailed procedure of the display control processing to be performed by the display control unit which is configured through the application of the game machine, the display control method, and the display control program according to the embodiment of the present invention.

The flowchart shown in FIG. 18 is similar to that shown in FIG. 17. In FIG. 18, the display control unit which constitutes the performance control unit (VDP) of the game machine starts processing when it receives a display request from the performance control board 120 with a polygon-based three-dimensional object stored in the CG ROM 151. The display control unit 200 decides whether the display request received is a previously-specified one (S1801).

As mentioned previously, the display request here is specified by a performance pattern specification command. The display control unit 200 decides whether the performance pattern specification command is one for providing a predetermined performance (S1801). In this decision processing, the display control unit 200 decides whether the display request is in a performance state that is specified by the “display condition information” stored in advance.

If the display request is in the performance state specified by the “display condition information” (YES at S1801), for example, if a display request for pseudo wire frame performance is registered in the “display condition information” and the display request received is one for pseudo wire frame performance using a three-dimensional object, the display request is decided to be in the predetermined performance state. In such a case, the display control unit 200 reads object information on the “three-dimensional object” that constitutes the performance image to be displayed on the basis of the display request that is stored in the CG ROM 151 (S1802). The display control unit 200 stores the object information into a temporary storing area such as a cache.

As mentioned previously, the “three-dimensional object” is an object composed of polygons which are surface forming information for forming a solid shape.

The display control unit 200 extracts the vertex coordinates that constitute the polygonal surfaces of the read “three-dimensional object” (for example, the coordinates of three vertexes if the surface is triangular; the coordinates of four vertexes if the surface is rectangular), i.e., spatial coordinates in the three-dimensional virtual space (S1803).

Next, the display control unit 200 reads the “vertex coordinate erase information” which is stored in advance (S1804).

As mentioned previously, the “vertex coordinate erase information” is information for identifying the vertex coordinates to be erased among the vertex coordinates extracted. An example of the vertex coordinate erase information is (1) information that allows successive identification of the vertex coordinates to be erased. Assuming that vertex coordinates adjoining certain vertex coordinates are to be erased, “other vertex coordinates” adjoining the vertex coordinates identified to be erased are excluded from the vertex coordinates to be erased. Vertex coordinates adjoining the “other vertex coordinates,” other than those excluded from the vertex coordinates to be erased, are then identified as vertex coordinates to be erased.

(2) In another example, vertex coordinate numbers may be temporarily assigned to the respective sets of vertex coordinates. Vertex coordinates having the same vertex coordinate number as a generated random number value may be identified as vertex coordinates to be erased.

(3) In yet another example, certain vertex coordinates to be erased may be specified in advance. Alternatively, a range of vertex coordinates to be erased may be specified. The corresponding vertex coordinates are then identified as ones to be erased.

Reading such “vertex coordinate erase information,” the display control unit 200 identifies the vertex coordinates specified by the “vertex coordinate erase information” (S1805), and erases the vertex coordinates identified (S1806).

The erasure reduces the number of vertex coordinates as compared to the read three-dimensional object, thereby forming a three-dimensional object with a smaller number of polygons.

On the remaining vertex coordinates of the three-dimensional object, the display control unit 200 then performs line drawing control processing to draw lines between the vertex coordinates on the basis of a performance condition specified in advance (S1807).

The line drawing control processing is to draw straight lines between the extracted vertex coordinates, thereby generating a three-dimensional object composed of a pseudo wire frame which can visualize a three-dimensional model.

The detailed procedure of the line drawing control processing is shown in the flowcharts of FIGS. 19 and 20, which will be described later.

After the drawing of lines between the vertex coordinates of the three-dimensional object through such line drawing control processing, the display control unit 200 draws a three-dimensional performance image to be displayed on the liquid crystal display based on the three-dimensional object (S1808). The display control unit 200 stores the drawn three-dimensional performance image into the VRAM (S1809).

When the three-dimensional performance image is thus stored in the VRAM, the image control unit (VDP) 2000 reads the three-dimensional performance image stored in the VRAM and displays the image on the liquid crystal display 31.

The foregoing description has dealt with the processing where the display request received is in the performance state that is specified by the “display condition information” based on the performance pattern specification command. If the display request received is not in the performance state specified by the “display condition information” based on the performance pattern specification command (NO at S1801), the display control unit 200 reads image data that constitutes the performance image based on the performance pattern specification command of that display request from the CG ROM 151 (S1810). The display control 200 draws the performance image to be displayed on the liquid crystal display on the basis of the read image data (S1811).

After the drawing of the performance image, the display control unit 200 stores the performance image into the VRAM (S1812).

Again, when the three-dimensional performance image is stored in the VRAM, the image control unit (VDP) 2000 reads the three-dimensional performance image stored in the VRAM and displays the image on the liquid crystal display 31.

FIG. 19 is a flowchart showing the detailed procedure of the line drawing control processing which is shown in the flowcharts of FIGS. 17 and 18.

In FIG. 19, the display control unit 200 identifies vertex coordinates adjoining to each set of vertex coordinates of the three-dimensional object (S1901).

After the identification of adjoining vertex coordinates, the display control unit 200 performs line drawing processing to connect the identified vertex coordinates by lines (S1902). Subsequently, the display control unit 200 decides whether the line drawing processing is performed on all the vertex coordinates of the three-dimensional object (S1903). If the line drawing processing is performed on all the vertex coordinates (YES at S1903), the display control unit 200 ends the processing. If the line drawing processing is not performed on all the vertex coordinates (NO at S1903), the display control unit 220 repeats the processing from step S1901.

FIG. 20 is a flowchart showing the detailed procedure of the line drawing control processing which is shown in the flowcharts of FIGS. 17 and 18.

FIG. 20 is similar to FIG. 19. The display control unit 200 identifies vertex coordinates adjoining to each set of vertex coordinates of the three-dimensional object (S2101).

After the identification of adjoining vertex coordinates, the display control unit 200 performs line drawing processing to connect the identified vertex coordinates by lines (S2102). Next, the display control unit 200 reads the “line delete information” which is stored in advance (S2103).

The “line delete information” is information for specifying lines to be deleted among the lines drawn by the line drawing processing. The display control unit 200 identifies the lines that are specified by the “line delete information” with respect to the performance condition (S2104). The display control unit 200 deletes the lines identified (S2105).

The display control unit 200 then decides whether the line drawing processing is performed on all the vertex coordinates of the three-dimensional object (S2106). If the line drawing processing is performed on all the vertex coordinates (YES at S2106), the display control unit 200 ends the processing. If the line drawing processing is not performed on all the vertex coordinates (NO at S2106), the display control unit 200 repeats the processing from step S2101.

### Practical Example 2

This practical example 2 shows another example of the embodiment of the present invention described in the foregoing practical example 1.

As in the foregoing practical example 1, the game machine according to the present practical example 2 to be described below has the structure shown in FIGS. 1 to 3. The game machine also has the block configuration shown in FIGS. 4 and 5. The game machine performs processing according to the flowcharts shown in FIGS. 9 to 16 of the practical example 1.

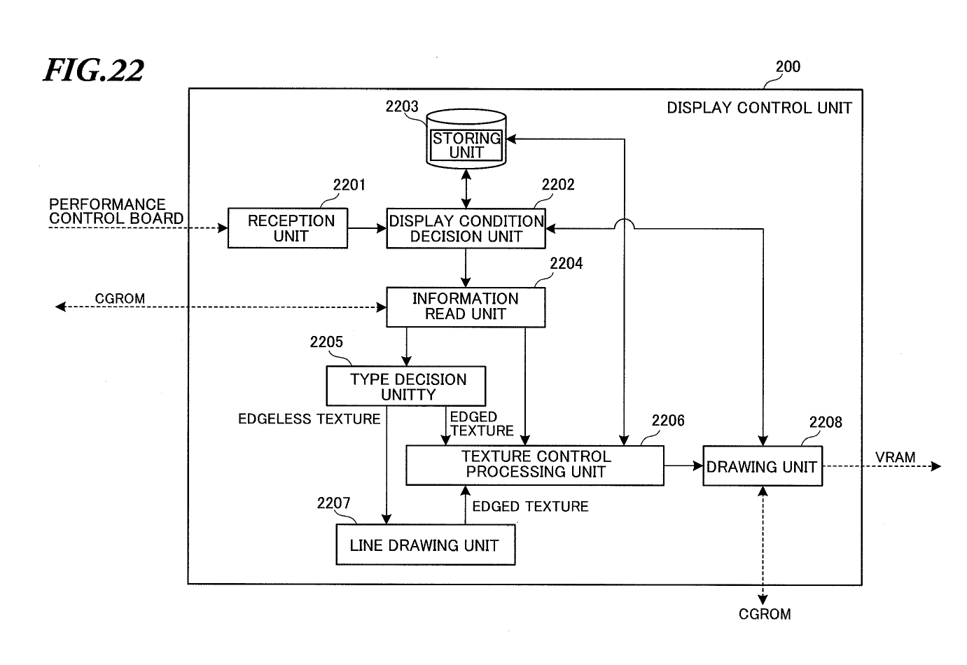

FIG. 22 is another block diagram showing the detailed configuration of the display control unit 200 included in the image control unit (VDP) that constitutes the image control board shown in FIG. 5, which has been used in the description of the practical example 1. FIG. 22 is similar to FIG. 6 which is the block diagram showing the detailed configuration of the display control unit 200.

In FIG. 22, the display control unit 200 includes a reception unit 2201, a display condition decision unit 2202, a storing unit 2203, an information read unit 2204, a type decision unit 2205, a texture control processing unit 2206, a line drawing unit 2207, and a drawing unit 2208.

When the reception unit 2201 receives a display request for a performance image based on a performance pattern specification command from the performance control board 120, the reception unit 2201 transmits the display request to the display condition decision unit 2202. Here, the display condition decision unit 2202 acquires “display condition information” stored in the storing unit 2203.

While the storing unit 2203 is included in the display control unit 200, it is not limited to such a configuration and may be arranged outside the image control unit (VDP) 2000.

The “display condition information” is condition information that specifies the display request for the display control unit 200 to perform display control processing. For example, the “display condition information” includes a display request for pseudo wire frame performance which is set by a performance pattern specification command.

If the display request transmitted from the reception unit 2201 is decided to be a display request for pseudo wire frame performance specified by the “display condition information,” the display condition decision unit 2202 issues a display request for a performance image based on the display request to the information read unit 2204.

On the other hand, if the display request transmitted from the reception unit 2201 is not included in the display request set by the “display condition information,” the display condition decision unit 2202 instructs the drawing unit 2208 to draw a performance image based on the display request transmitted from the reception unit 2201. When the drawing unit 2208 is instructed by the display condition decision unit 2202 to draw a performance image, the drawing unit 2208 acquires image data to be used for drawing the instructed performance image, such as performance symbols and background images (movie), from the CG ROM 151 and draws the performance image based on the display request. The drawing unit 2208 stores the drawn performance image into a buffer of the VRAM.

When a display request is given from the display condition decision unit 2202, the information read unit 2204 reads a three-dimensional object composed of polygons (also referred to as “polygon object”) and a “texture” from the CG ROM 151 as image data to be used for drawing the performance image based on the display request. The texture is a material image for expressing the surface texture of the three-dimensional object.

The polygons are surface forming information for forming the three-dimensional object, a solid shape. The polygon data is expressed in terms of polygonal shapes. The polygons are used to shape the three-dimensional object.

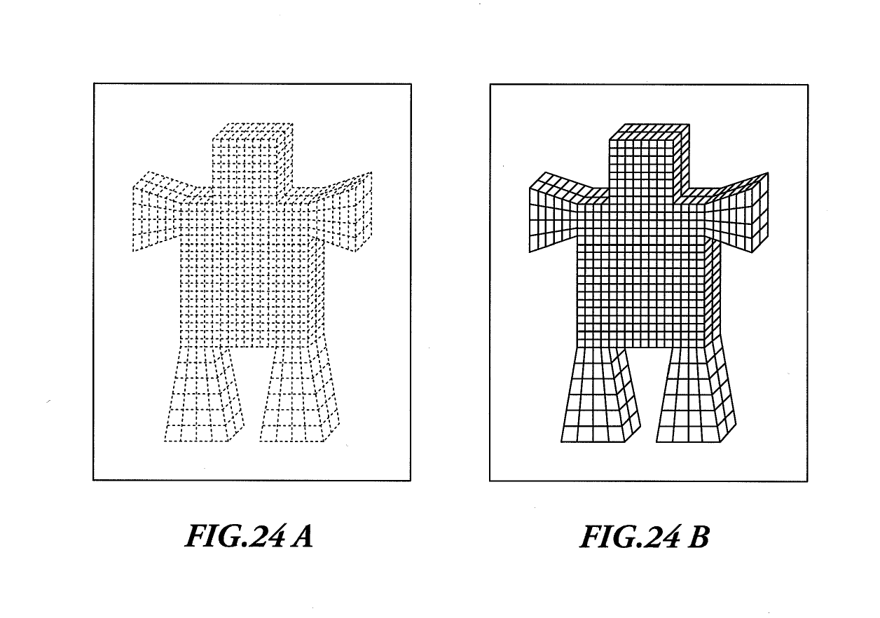

For example, FIG. 24A shows an example of a three-dimensional robot object which is expressed by a plurality of polygons. The three-dimensional object shown in FIG. 24A is information that expresses the shape by polygons. The surface texture of such a three-dimensional object is expressed by a texture.

Reading the three-dimensional object and the texture, the information read unit 2204 transmits the texture and information on the texture, or the filename of the read texture, to the type decision unit 2205. The information read unit 2204 transmits the read three-dimensional object to the texture control processing unit 2206.

Based on the information on the texture or the filename of the read texture, the type decision unit 2205 decides the type of the texture whether it is an “edged texture,” whose texture edges or “edge parts” are hemmed with lines, or an “edgeless texture.” If, according to the decision processing, the texture is decided to be an “edged texture” whose edge parts are hemmed with lines, the type decision unit 2205 transmits the texture to the texture control processing unit 2206. If the texture is decided to be an “edgeless texture” whose edge parts are not hemmed with lines, the type decision unit 2205 transmits the texture to the line drawing unit 2207.

The line drawing unit 2207 performs processing to hem the edge parts of the read texture with lines, and transmits the resulting texture whose edge parts are hemmed with lines to the texture control processing unit 2206.

Receiving the texture whose edge parts are hemmed with lines from the type decision unit 2205 or the line drawing unit 2207, the texture control processing unit 2206 performs texture control processing to map the texture onto the three-dimensional object that is received from the information read unit 204 and temporarily cached.

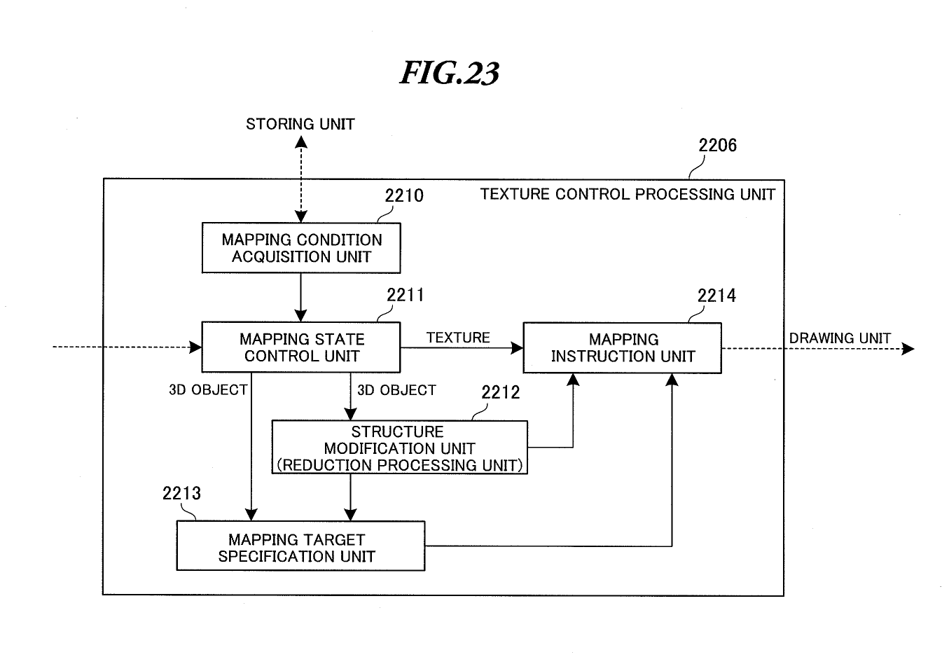

The detailed configuration of the texture control processing unit 2206 for performing the “texture control processing” is shown in FIG. 23, which will be described later.

After the mapping of the texture onto the three-dimensional object, the texture control processing unit 2206 transmits the texture-mapped three-dimensional object to the drawing unit 2208, and issues a drawing instruction.

The drawing unit 2208 then draws a performance image based on the three-dimensional object and stores the performance image into the VRAM. An example of the three-dimensional object that is drawn by the drawing unit 2208 and stored in the VRAM is shown in FIG. 24B, which is drawn and displayed when a texture is mapped onto the three-dimensional object shown in FIG. 24A.

FIG. 23 is a block diagram showing the detailed configuration of the texture control processing unit 2206 shown in FIG. 22.

In FIG. 23, the texture control processing unit 2206 includes a mapping condition acquisition unit 2210, a mapping state control unit 2211, a structure modification unit 2212, a mapping target specification unit 2213, and a mapping instruction unit 2214.

The mapping state control unit 2211 receives the three-dimensional object from the information read unit 2204 shown in FIG. 22, and temporarily stores the three-dimensional object into a not-shown cache. The mapping state control unit 2211 also receives the edged texture from the type decision unit 2205 or the line drawing unit 2207, and temporarily stores the edged texture into the cache.

With the three-dimensional object and texture stored in the cache, the mapping state control unit 2211 requests the mapping condition acquisition unit 2210 to acquire a mapping condition. In response, the mapping condition acquisition unit 2210 acquires “mapping condition information” which is stored in the storing unit 2203 shown in FIG. 22. The mapping condition acquisition unit 2210 transmits the acquired “mapping condition information” to the requesting mapping state control unit 2211.

The “mapping condition information” is information that specifies the “mapping condition” under which the texture is mapped onto the polygons of the three-dimensional object. The information specifies whether or not to perform polygon reduction processing to reduce the number of polygons. If it is specified to perform the polygon reduction processing, a reduction condition is also specified.

The “mapping condition information” also specifies either “(1) the texture be mapped in units of polygons” or “(2) the texture be mapped with a plurality of polygons as a single unit of mapping.” In particular, if it is specified that “(2) the texture be mapped with a plurality of polygons as a single unit of mapping,” the information also specifies as the reduction condition the number of polygons to be a unit of mapping and the method of setting target polygons.

Receiving the “mapping condition information” from the mapping condition acquisition unit 2210, the mapping state control unit 2211 decides whether or not to perform the polygon reduction processing which is specified by the mapping condition information. If it is decided to perform the polygon reduction processing, the mapping state control unit 2211 further decides which the “mapping condition information” includes, “(1) the texture be mapped in units of polygons” or “(2) the texture be mapped with a plurality of polygons as a single unit of mapping.” The mapping state control unit 2211 transmits the decision result, and if it is decided that “(2) the texture be mapped with a plurality of polygons as a single unit of mapping,” the specified information on “the number of polygons to be a unit of mapping and the method of setting target polygons” as well, to the structure modification unit 2212. The mapping state control unit 2211 issues an instruction for the reduction processing on the three-dimensional object.

On the other hand, if it is decided not to perform the polygon reduction processing, the mapping state control unit 2211 further decides which the “mapping condition information” includes, “(1) the texture be mapped in units of polygons” or “(2) the texture be mapped with a plurality of polygons as a single unit of mapping.” The mapping state control unit 2211 transmits the decision result, and if it is decided that “(2) the texture be mapped with a plurality of polygons as a single unit of mapping,” the specified information on the reduction condition of “the number of polygons to be a unit of mapping and the method of setting target polygons” as well, to the mapping target specification unit 2213.

The mapping state control unit 2211 further transmits the texture to the mapping instruction unit 2214.

If it is decided to perform the polygon reduction processing and the structure modification unit 2212 receives the three-dimensional object, the structure modification unit 2212 performs the polygon reduction processing to reduce the number of polygons.

The polygon reduction processing performed by the structure modification unit 2212 reduces the number of vertexes while preserving the shape of the polygon-based three-dimensional object as much as possible, thereby reducing the total number of polygons that constitute the three-dimensional object. In this reduction processing, the curvatures between adjoining polygons are calculated to identify polygons that have a curvature lower than or equal to a certain value, and the numbers of vertexes of such polygons are thereby reduced.

More specifically, flat portions of the three-dimensional object with not much projections and depressions have a curvature of a certain value or below by this polygon reduction processing. A lot of vertexes can thus be reduced to reduce the total number of polygons.

After such polygon reduction processing, the structure modification unit 2212 transmits the three-dimensional object resulting from the reduction processing to the mapping instruction unit 2214.

Suppose that the structure modification unit 2212 has received the decision result of either “(1) the texture be mapped in units of polygons” or “(2) the texture be mapped with a plurality of polygons as a single unit of mapping” from the mapping state control unit 2211. In such a case, the structure modification unit 2212 transmits the information on the decision result and that information (information that specifies whether “(1) the texture be mapped in units of polygons” or “(2) the texture be mapped with a plurality of polygons as a single unit of mapping”) to the mapping target specification unit 2213 along with the three-dimensional object resulting from the reduction processing.

Now, if it is decided not to perform the polygon reduction processing, the mapping target specification unit 2213 receives the three-dimensional object from the mapping state control unit 2211. If it is decided that “(1) the texture be mapped in units of polygons” on the basis of the decision result received from the mapping condition control unit 2211 as to whether “(1) the texture be mapped in units of polygons” or “(2) the texture be mapped with a plurality of polygons as a single unit of mapping,” the mapping target specification unit 2213 specifies that the texture be mapped onto each polygon constituting the three-dimensional object. The mapping target specification unit 2213 then transmits the specification information to the mapping instruction unit 2214.

If it is decided that “(2) the texture be mapped with a plurality of polygons as a single unit of mapping,” the mapping target specification unit 2213 specifies polygons to map the texture on, on the basis of the reduction condition, i.e., the information on “the number of polygons to be a unit of mapping and the method of setting target polygons,” and transmits the three-dimensional object to the mapping instruction unit 2214.

When receiving the three-dimensional object also from the structure modification unit 2212, the mapping target specification unit 2213 performs the same processing as when receiving the three-dimensional object from the mapping state control unit 2211.

The mapping instruction unit 2214 then issues an instruction for the mapping of the texture received from the mapping state control unit 2211 onto the specified polygons, and transmits the instruction to the drawing unit 2208.

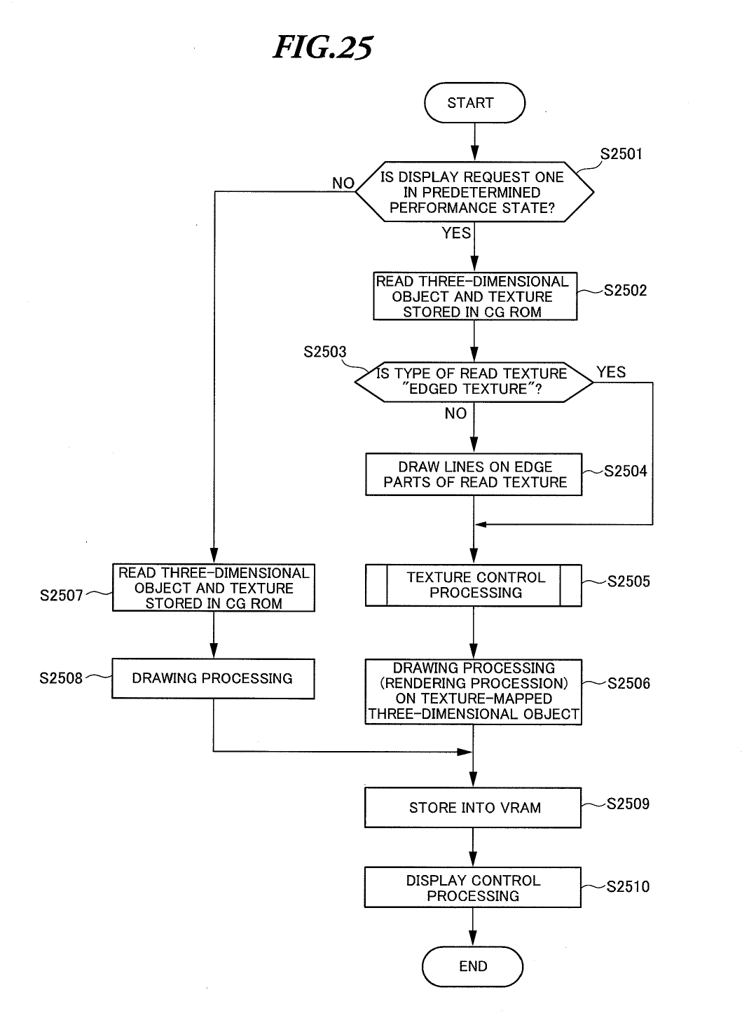

FIG. 25 is a flowchart showing the procedure of processing to be performed by the display control unit of the game machine which is configured through the application of the game machine, the display control method, and the display control program according to the embodiment of the present invention.

In FIG. 25, the display control unit 200 starts processing when it receives a display request for a performance image based on a performance pattern specification command from the performance control board. The display control unit 200 decides whether the display request is one in a predetermined performance state (performance pattern specification command for providing a predetermined performance) (S2501). In the decision processing, the display control unit 200 decides whether the display request is in a performance state that is specified by the “display condition information” stored in advance.

When the display request is in the performance state specified by the “display condition information” (YES at S2501), for example, if a display request for pseudo wire frame performance is registered in the “display condition information” and the display request received is one for pseudo wire frame performance using a three-dimensional object, then the display request is decided to be in the predetermined performance state. In such a case, the display control unit 200 reads the “three-dimensional object” and the “texture” that constitute the performance image to be displayed on the basis of the display request, stored in the CG ROM 151 (S2502). The display control unit 200 stores the read “three-dimensional object” and “texture” into a temporary storing area such as a cache.

As mentioned previously, the “three-dimensional object” is an object composed of polygons which are surface forming information for forming the shape of a solid shape. The “texture” is used to express the surface texture of the object.

Based on the information on the read “three-dimensional object” and “texture,” or based on the filenames or the like of the “three-dimensional object” and “texture,” the display control unit 200 decides at least whether or not the read texture is an “edged texture” whose texture edges or “edge parts” are hemmed with lines (S2503).

If the read texture is not decided to be an “edged texture” (NO at S2503), for example, if the type field of the information on the texture does not contain “edged” or the filename is not so specified, the display control unit 200 performs processing to hem the edge parts of the read texture with lines (S2504). The display control unit 200 then stores the texture whose edge parts are hemmed with lines into a temporary storing area.

Consequently, the temporary storing area stores either the texture whose edge parts are drawn by lines or the texture that is stored in the CG ROM 151 with its edge parts drawn by lines.

If the read texture is an “edged texture” (YES at S2503), or in the foregoing example the type field of the information on the texture contains “edged,” the display control unit 200 performs the “texture control processing” by using the read texture (S2505). On the other hand, if the read texture is not an “edged texture” (NO at S2503), the display control unit 200 performs the “texture control processing” by using the texture whose edge parts are hemmed with lines (S2505).

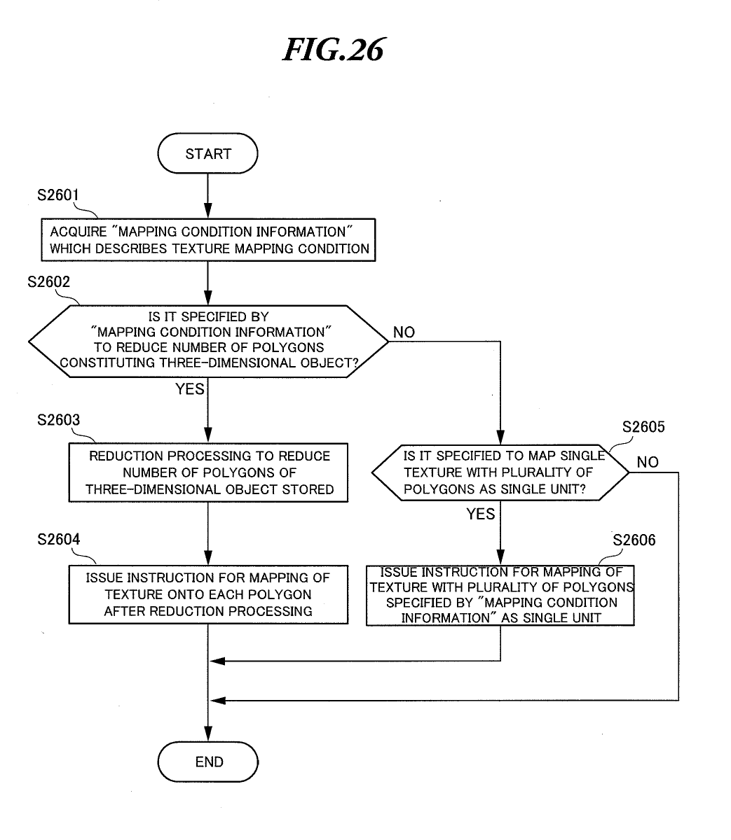

The “texture control processing” is control processing to issue an instruction for the mapping of the “texture,” which expresses the surface texture of the three-dimensional object, onto the polygons of the read three-dimensional object. The detailed procedure of the “texture control processing” is shown in the flowchart of FIG. 26, and will be described below with reference to FIG. 26.

By the “texture control processing,” a texture control is performed on the three-dimensional object, and an instruction for the mapping of the texture onto the polygon data on the three-dimensional object is given. Based on the instruction, the display control unit 200 maps the texture onto the three-dimensional object, and draws (renders) the performance image of the three-dimensional object by using viewpoint information, shape information, and information on the light source, shading, and the like which are specified in advance (S2506).

After the drawing (rendering) of the performance image of the three-dimensional object, the display control unit 200 stores the performance image into the VRAM (S2509). Specifically, the performance image is stored into the buffer of the VRAM.

After the performance image is drawn and stored into the VRAM, the display control unit 200 performs a display control to read the performance image stored in the VRAM and display the performance image on the liquid crystal display 31 (S2510).

The foregoing processing is for the case where the display request based on the performance pattern specification command is in a predetermined performance state. If, on the other hand, the display request based on the performance pattern specification command is not decided to be in the predetermined performance state (NO at S2501), or in the foregoing example the display request is not the one specified by the “display condition information,” the display control unit 200 reads the “three-dimensional object” and “texture” stored in the CG ROM 151 (S2507). The display control unit 200 then draws the performance image based on the display request (S2508).

After the drawing of the performance image based on the three-dimensional object, the display control unit 200 stores the drawn performance image into the VRAM (S2509). Specifically, the performance image is stored into the buffer of the VRAM.

The display control unit 200 then performs a display control to read the performance image stored in the VRAM and display the image on the display (S2510).

FIG. 26 is a flowchart showing the detailed procedure of the “texture control processing” which is included in the flowchart of FIG. 25.

In FIG. 26, the “three-dimensional object” and “texture” stored in the CG ROM 151 are read, and if the texture is not an edged texture, lines are drawn on the edge parts. In such a state, the display control unit 200 initially acquires the “mapping condition information” which describes the texture mapping condition (S2601).

The “mapping condition information” is information that specifies the mapping condition under which the texture is mapped onto the polygons of the three-dimensional object. The information specifies whether or not to perform polygon reduction processing to reduce the number of polygons. If it is specified to perform the polygon reduction processing, a reduction condition is also specified.

The mapping condition information also specifies either “(1) the texture be mapped in units of polygons” or “(2) the texture be mapped with a plurality of polygons as a single unit of mapping.” In particular, if it is specified that “(2) the texture be mapped with a plurality of polygons as a single unit of mapping,” the information also specifies the number of polygons to be a unit of mapping and the method of setting target polygons.

Acquiring such “mapping condition information,” the display control unit 200 decides whether it is specified by the “mapping condition information” to reduce the number of polygons that constitute the three-dimensional object (S2602). If it is specified to perform the reduction processing to reduce the number of polygons (YES at S2602), the display control unit 200 performs the polygon reduction processing to reduce the number of polygons that constitute the three-dimensional object (S2603).

The polygon reduction processing reduces the number of vertexes while preserving the shape of the polygon-based three-dimensional object as much as possible, thereby reducing the number of polygons. In this reduction processing, the curvatures between adjoining polygons are calculated to identify polygons that have a curvature lower than or equal to a certain value, and the numbers of vertexes of such polygons are thereby reduced. Flat portions of the three-dimensional object with not much projections and depressions have a curvature of a certain value or below. A lot of vertexes can thus be reduced to reduce the total number of polygons.

After such polygon reduction processing, the display control unit 200 issues an instruction for the mapping of the texture onto each of the polygons resulting from the reduction processing (S2604).

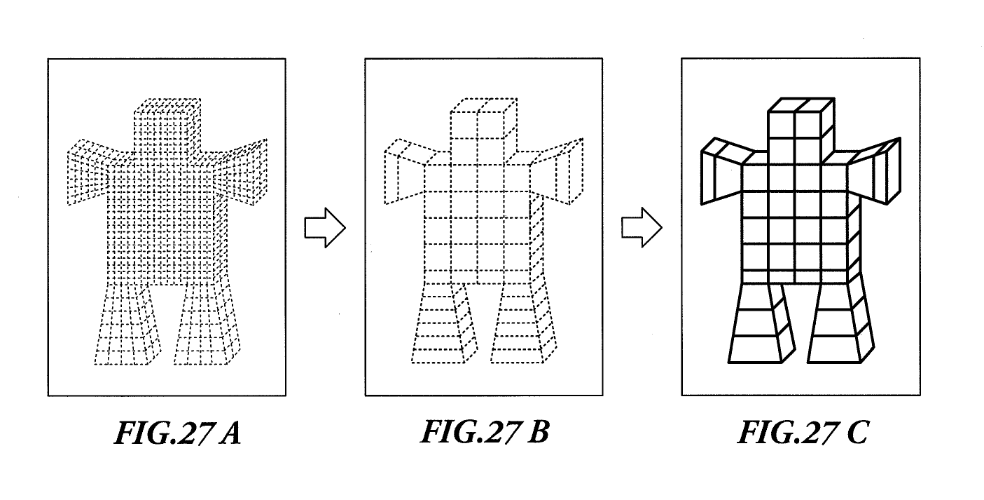

FIGS. 27A to 27C show an example of the three-dimensional object that is given the polygon reduction processing.

FIG. 27A is a diagram showing an example of the polygon-based three-dimensional object stored in the CG ROM 151. Each polygon is shown by dotted lines. FIG. 27B is a diagram showing an example of the three-dimensional object where the number of polygons is reduced by reducing the number of vertexes of the three-dimensional object through the polygon reduction processing.

FIG. 27C is a diagram showing the state where a transparent texture having edge parts hemmed with lines is mapped onto each polygon of the three-dimensional object that is given the polygon reduction processing shown in FIG. 27B.

In FIG. 27C, since a transparent texture is mapped onto the three-dimensional object, a pseudo wire frame is drawn along the edge parts of the texture.

Now, if it is not specified to perform the reduction processing to reduce the number of polygons (NO at S2602), the display control unit 200 decides whether it is specified to map the texture with a plurality of polygons as a single unit of mapping (S2605). If it is specified to map the texture with a plurality of polygons as a single unit of mapping (YES at S2605), the display control unit 200 issues an instruction to map the texture on the basis of the number of polygons to be a mapping unit and the target polygons, which are set by the “mapping condition information” (S2606).

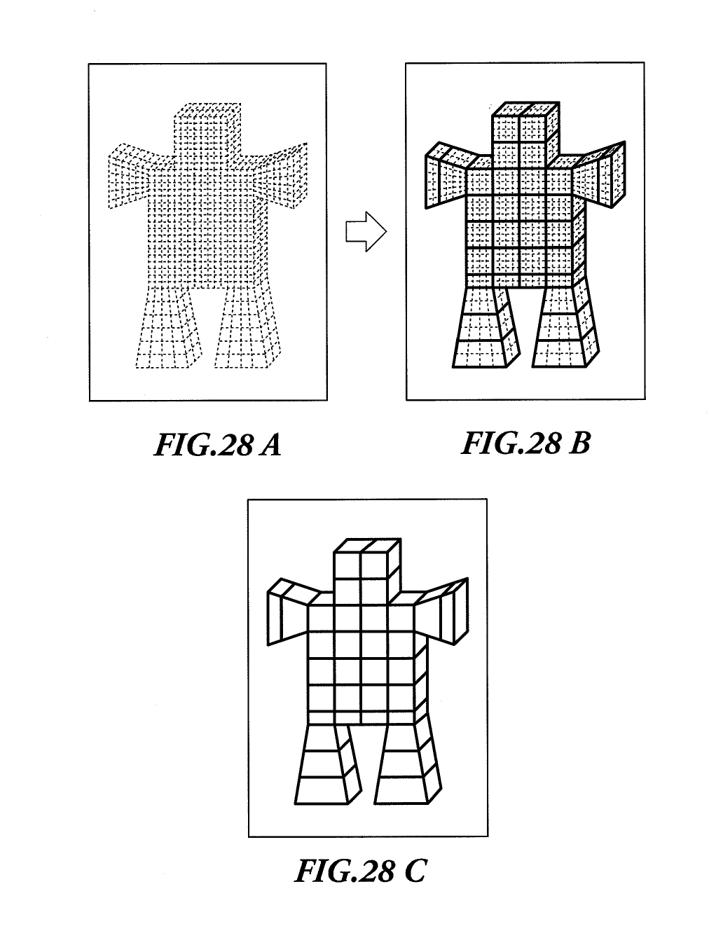

FIGS. 28A to 28C shows such a state.

Like FIG. 27A, FIG. 28A is a diagram showing an example of the polygon-based three-dimensional object stored in the CG ROM 151. Each polygon is shown by dotted lines. FIG. 28B shows an example where a transparent texture having edge parts hemmed with lines is mapped with a plurality of polygons as a single unit of mapping. FIG. 28B shows the dotted lines that indicate the polygons.

The dotted lines indicating the polygons of FIG. 28B are only intended to show the shape of the three-dimensional object. The actual display on the liquid crystal display 31 is such as shown in FIG. 28C.

The foregoing embodiments are just a few embodiments of the present invention. The present invention is not limited to such embodiments, and modifications may be made as appropriate without changing the gist of the invention.

It should be noted that the present invention may also provide a computer that performs the foregoing processing, by installing programs for implementing the foregoing means on the computer from a recording medium (such as a CD-ROM and a DVD-ROM) storing the programs, and executing the same. The computer here includes a CPU (Central Processing Unit), a ROM (Read Only Memory), a RAM (Random Access Memory), and a hard disk which are connected through a system bus. The CPU performs processing according to the programs stored in the ROM or the hard disk, using the RAM as the work area.

The medium for supplying the programs may be a communication medium (a medium that temporarily or fluidly retains programs, such as a communication line and a communication system). For example, the programs may be posted to a bulletin board service (BBS) of a communication network and distributed through communication lines.

1. A game machine, comprising:
a display device configured to display a three-dimensional performance image corresponding to a performance state provided by a game using a game medium;
a three-dimensional object storing device configured to store a three-dimensional object generated from polygonal data that connects vertex coordinates in a three-dimensional virtual space;
a vertex coordinate extracting device configured to extract the vertex coordinates of the polygonal data constituting the three-dimensional object stored in the three-dimensional object storing device;
a line drawing control device configured to perform a line drawing control on lines between the vertex coordinates of the polygonal data extracted by the vertex coordinate extracting device, on the basis of a performance condition corresponding to the performance state;
a drawing device configured to draw the three-dimensional performance image on the basis of the three-dimensional object on whose lines the line drawing control is performed by the line drawing control device; and
a display control device configured to display and controlling control the three-dimensional performance image drawn by the drawing device on the display device.

2. The game machine according to claim 1, further comprising a vertex coordinate erase device configured to erase part of the vertex coordinates of the polygonal data extracted by the vertex coordinate extracting device, and wherein
the line drawing control device is configured to perform the drawing control on lines between the vertex coordinates that remain after the erasure of part of the vertex coordinates by the vertex coordinate erase device, on the basis of the performance condition corresponding to the performance state.

3. The game machine invention according to claim 2, further comprising a vertex coordinate information storing device configured to store vertex coordinate erase information that specifies vertex coordinates to be erased in association with the performance state among the vertex coordinates extracted by the vertex coordinate extracting device, and wherein
the vertex coordinate erase device is configured to erase the vertex coordinates specified by the vertex coordinate erase information stored in the vertex coordinate information storing device.

4. The game machine according to claim 1, wherein:
the line drawing control device further comprises
a line drawing device configured to draw lines between adjoining vertex coordinates among the vertex coordinates of the polygonal data extracted by the vertex coordinate extracting device, and
a line delete device configured to delete part of the lines of the three-dimensional object on the basis of the performance condition corresponding to the performance state, the lines being drawn between the vertex coordinates of the polygonal data by the line drawing device; and
the drawing device is configured to draw the three-dimensional performance image on the basis of the three-dimensional object of which part of the lines between the vertex coordinates of the polygonal data are deleted by the line delete device.

5. The game machine according to claim 4, further comprising a line drawing information storing device configured to store line delete information that specifies lines to be deleted in association with the performance state among the lines on which the line drawing control is performed by the line drawing control device, and wherein
the line delete device is configured to delete the lines specified by the line delete information stored in the line drawing information storing device.

6. The game machine according to claim 4, wherein the line delete device is configured to delete diagonal lines of rectangular data among the polygonal data on the three-dimensional object.

7. A game machine, comprising:
a three-dimensional object storing device configured to store a three-dimensional object in association with a performance state provided by a game using a game medium, the three-dimensional object being generated from polygonal data that connects vertex coordinates in a three-dimensional virtual space;
a material image storing device configured to store a material image that expresses an object surface of the three-dimensional object constituted by the polygonal data;
a line control device configured to perform a line control to draw lines on the material image stored in the material image storing device; and
a display control device configured to display and control a three-dimensional object whose outer shape is expressed by the lines when being in a predetermined performance state, by using the material image that results from the line control of the line control device on the polygonal data constituting the three-dimensional object stored in the three-dimensional object storing device.

8. The game machine according to claim 7, wherein the line control device further comprises a mapping device configured to map the material image stored in the material image storing device onto the polygonal data constituting the three-dimensional object.

9. The game machine according to claim 8, further comprising a specification device configured to specify a plurality of pieces of polygonal data constituting the three-dimensional object, and wherein:
the mapping device is configured to map the material image stored in the material image storing device with the plurality of pieces of polygonal data specified by the specification device as a single unit; and
the display control device is configured to display and control the three-dimensional object onto whose polygonal data the material image is mapped by the mapping device and whose outer shape is expressed by the lines.

10. The game machine according to claim 9, comprising a generating device configured to generate a three-dimensional object by reducing the number of pieces of polygonal data constituting the three-dimensional object stored in the three-dimensional object storing device, and wherein
the mapping device is configured to map the material image stored in the material image storing device onto polygonal data on the three-dimensional object generated by the generating device.

11. The game machine according to claim 7, wherein:
the material image storing device is configured to store a material image whose edge parts are hemmed with lines; and
the display control device is configured to display and control the three-dimensional object onto whose polygonal data the material image is mapped.

12. The game machine according to claim 7, wherein:
the material image storing device is configured to store a fully transparent material image;
the line control device further comprises a line drawing device configured to draw lines on edge parts of the material image stored in the material image storing device; and
the display control device is configured to display and control the three-dimensional object onto whose polygonal data the material image is mapped, the material image having lines drawn on its edge parts by the line drawing device.

13. The game machine according to claim 7, wherein the line control device further comprises a hidden line removal processing device configured to perform hidden line removal processing on the lines that hem edge parts of the polygonal data on the three-dimensional object, the edge parts being hidden when the three-dimensional object is displayed.

14. The game machine according to claim 13, wherein the hidden line removal processing device is configured to perform the hidden line removal processing on diagonal lines of rectangular polygon data if the polygonal data on the three-dimensional object includes the rectangular polygon data.

15. The game machine according to claim 13, further comprising a condition decision device configured to decide whether there arises the performance state that satisfies a display condition of the three-dimensional object, and wherein
the mapping device is configured to map the material image when the condition decision device decides that the display condition is satisfied.

16. A display control method, comprising:
storing, by a three-dimensional object storing device, a three-dimensional object generated from polygonal data that connects vertex coordinates in a three-dimensional virtual space;
extracting, by a vertex coordinate extracting device, the vertex coordinates of the polygonal data constituting the three-dimensional object stored in the three-dimensional object storing device;
performing, by a control device, a line drawing control on lines between the vertex coordinates of the polygonal data extracted by the vertex coordinate extracting device, on the basis of a performance condition corresponding to a performance state;
drawing, by a drawing device, the three-dimensional performance image on the basis of the three-dimensional object on whose lines the line drawing control is performed by the control device; and
displaying and controlling, by a display control device, the three-dimensional performance image drawn by the drawing device on a display device.

17. A display control method, comprising:
storing, by a three-dimensional object storing device, a three-dimensional object in association with a performance state provided by a game using a game medium, the three-dimensional object being generated from polygonal data that connects vertex coordinates in a three-dimensional virtual space;
storing, by a material image storing device, a material image that expresses an object surface of the three-dimensional object constituted by the polygonal data;
performing, by a line control device, a line control to draw lines on the material image stored in the material image storing device; and
displaying and controlling the three-dimensional object whose outer shape is expressed by the lines when being in a predetermined performance state, by using the material image that results from the line control of the line control device on the polygonal data constituting the three-dimensional object stored in the three-dimensional object storing device.

18. A non-transitory digital storage medium having stored thereon a computer program with a program code for performing, when the program is executed on a computer, a display control method comprising:
storing, by a three-dimensional object storing device, a three-dimensional object generated from polygonal data that connects vertex coordinates in a three-dimensional virtual space;
extracting, by a vertex coordinate extracting device, the vertex coordinates of the polygonal data constituting the three-dimensional object stored in the three-dimensional object storing device;
performing, by a line drawing control device, a line drawing control on lines between the vertex coordinates of the polygonal data extracted by the vertex coordinate extracting device, on the basis of a performance condition corresponding to a performance state;
drawing, by a drawing device, the three-dimensional performance image on the basis of the three-dimensional object on whose lines the line drawing control is performed by the line drawing control device; and
displaying and controlling, by a display control device, the three-dimensional performance image drawn by the drawing device on a display device.

19. A non-transitory digital storage medium having stored thereon a computer program with a program code for performing, when the program is executed on a computer, a display control method comprising:
storing, by a three-dimensional object storing device, a three-dimensional object in association with a performance state provided by a game using a game medium, the three-dimensional object being generated from polygonal data that connects vertex coordinates in a three-dimensional virtual space;
storing, by a material image storing device, a material image that expresses an object surface of the three-dimensional object constituted by the polygonal data;
performing, by a line control device, a line control to draw lines on the material image stored in the material image storing device; and
displaying and controlling, by a display control device, a three-dimensional object whose outer shape is expressed by the lines when being in a predetermined performance state, by using the material image that results from the line control of the line control device on the polygonal data constituting the three-dimensional object stored in the three-dimensional object storing device.
